(19) United States
(12) Patent Application Publication
(10) Pub. No.: US 2012/0048315 A1
(43) Pub. Date: Mar. 1, 2012

(54) BREAKAWAY SYSTEM FOR AUTO WASH BOOM ARM

(76) Inventors: Gregory D. Rollins, Arvada, CO (US); Matthew Kenneth Lambert, Denver, CO (US); Jesse Aaron Weifenbach, Thornton, CO (US); Roderick MacWilliam, Arvada, CO (US)

(21) Appl. No.: 13/286,885

(22) Filed: Nov. 1, 2011

Related U.S. Application Data
(63) Continuation-in-part of application No. 13/102,440, filed on May 6, 2011.
(60) Provisional application No. 61/332,655, filed on May 7, 2010.

(51) Int. Cl. B08B 3/00; B08B 7/00

(52) U.S. Cl. 134/56 R; 134/123

(57) ABSTRACT

In an automatic wash, a control unit operates a boom arm around a vehicle in a bay by moving a bridge along a lengthwise vehicle orientation, moving a trolley on the bridge along a widthwise vehicle orientation, and rotating the boom arm about the trolley. The boom arm is coupled to a mount which is flexibly coupled to the trolley such that boom arm impact displaces the mount and the trolley. The displacement may be two-dimensional and/or angular. In response, the control unit determines whether an impact has occurred by comparing the data to a baseline. If there is an impact, the control unit relocates the boom arm and may continue the wash process. If a sufficient force impact occurs that the control unit cannot correct, the boom arm may disengage from the mount which may trigger a breakaway sensor and cause the control unit to abandon the wash.

### CROSS REFERENCE TO RELATED APPLICATIONS

This application is a continuation-in-part of U.S. patent application Ser. No. 13/102,440 entitled “Automatic wash boom arm impact sensor system” filed 6 May 2011, which claims priority under 35 U.S.C. §119(e) to U.S. provisional application No. 61/332,655 entitled “Automatic wash boom arm impact sensor system” filed 7 May 2010, each of which is hereby incorporated herein by reference in its entirety.

### TECHNICAL FIELD

The disclosed embodiments relate generally to automatic car wash systems, and more particularly to a breakaway system for a boom arm for an automatic car wash.

### BACKGROUND

The washing of automotive vehicles has been automated for some years with various types of apparatus. For example, there are overhead type vehicular wash systems wherein a vertical boom arm is manipulated (such as by the direction of a control unit) to travel around the perimeter of the vehicle and spray the vehicle while the vehicle remains stationary. In such systems, the vertical boom arm may be rotatably coupled to a trolley, which is in turn movably coupled to a bridge mounted to a track system above the vehicle. The bridge may be reciprocated back and forth along the length of the vehicle. The trolley may be reciprocated back and forth on a portion of the bridge along the width of the vehicle. The vertical boom arm may be circularly rotated about a vertical axis extending through the trolley. Thus, via the movement of the bridge, the trolley, and the vertical boom arm, the vertical boom arm is manipulated to travel around the perimeter of the vehicle during the automatic wash process. As the vertical boom arm is manipulated around the perimeter of the vehicle, assumptions are generally made about the perimeter of the vehicle in order to prevent impact between the vertical boom arm and the vehicle during the automatic wash process. Different vehicles have different perimeters. Further, accessories such as trailer hitches, bike and ski racks, ramming plates, winches, and so on may alter the perimeter of the vehicle and may cause impact between the vertical boom arm and the vehicle, resulting in damage to the vehicular wash system and/or the vehicle.

Some gantry-type car washes may utilize a series of shear pins that function to keep the vertical boom arm in the vertical position. In such washes, impact between the vertical boom arm and the vehicle fractures one or more of the shear pins and forces the vertical boom arm away from the vehicle, stopping the wash process. Service personnel may then be required to reset the vertical boom arm and install new shear pins. Other gantry type car washes may utilize a stabilizing plate held in place by bias force of an air cylinder. In such washes, impact between the vertical boom arm and the vehicle may rotate the vertical boom arm to exert force upon the stabilizing plate against the bias force of the air cylinder. In response, the wash process is typically ended so that the vertical boom arm may be reset by the bias force of the air cylinder against the stabilizing plate.

The information included in this Background section of the specification, including any references cited herein and any description or discussion thereof, is included for technical reference purposes only and is not to be regarded subject matter by which the scope of the disclosure is to be bound.

### SUMMARY

A vertical boom arm for a vehicle wash system may include a breakaway mechanism that is operable to disengage the vertical boom arm when an impact occurs between the vertical boom arm and a vehicle and/or another object that is a greater impact than the control unit has the ability to correct for. In such implementations, the vertical boom arm may include a breakaway target plate assembly and one or more breakaway sensors which detect when a breakaway has occurred by detecting vertical displacement of the breakaway target plate. If the control unit determines that the breakaway sensor has detected a breakaway, the control unit may abandon the current wash and remain dormant until the breakaway mechanism is reset and the automatic vehicle wash is reset.

In an exemplary implementation, an operator resettable, breakaway wash arm mount for an automatic vehicle wash may be composed of a support structure, a wash arm, and a breakaway attachment mechanism. The wash arm may be pivotally coupled with the support structure about two separate axes. The breakaway attachment mechanism may be mounted either to the wash arm or to the support structure that in normal operation interfaces with the other of the wash arm or to the support structure opposite the breakaway attachment mechanism to maintain the wash arm in a fixed position with respect to the support structure. Upon an impact force to the wash arm from any direction in a horizontal plane sufficient to overcome a force supplied by the interface between the breakaway attachment mechanism and either the wash arm or the support structure, the breakaway attachment mechanism may disengage from either the wash arm or the support structure and allow the wash arm to pivotally move with respect to the support structure in a direction of the impact force. The breakaway attachment mechanism can be manually reset with respect to either the wash arm or the support structure.

In another exemplary implementation, an operator resettable, breakaway wash arm mount for an automatic vehicle wash may be composed of a support structure, a rotatable wash arm shaft, a wash arm, a detent plunger, a bias mechanism, and a detent receiver. The rotatable wash arm shaft may extend from the support structure. The wash arm may be pivotally coupled with the wash arm shaft about two separate axes. The detent plunger may be mounted either to the wash arm or to the wash arm shaft. The detent receiver may be mounted to the other of the wash arm or to the wash arm shaft opposite the detent plunger. The bias mechanism biases the detent plunger against the detent receiver. In normal operation, the detent plunger is retained in the detent receiver to maintain the wash arm in a fixed position with respect to the support structure. Upon an impact force to the wash arm from any direction in a horizontal plane sufficient to overcome a force supplied by the bias mechanism, the detent plunger may disengage from the detent receiver and allows the wash arm to pivotally move with respect to the support structure in a direction of the impact force. The detent plunger can be manually reset within the detent receiver.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present disclosure is provided in the following written description of various embodiments of the disclosure, illustrated in the accompanying drawings, and defined in the appended claims.

### BRIEF DESCRIPTION OF THE DRAWINGS

FIG. 1 is a front perspective view of an automatic vehicle wash system in accordance with the present disclosure.

FIGS. 2A through 2I are top plan views of the automatic vehicle wash system of FIG. 1 illustrating performance of a wash process.

FIG. 3 is a top plan view of the automatic vehicle wash system of FIG. 1 illustrating a first kind of impact between a vertical boom arm and an obstruction during a wash process.

FIGS. 4A through 4D are top plan views of the automatic vehicle wash system of FIG. 1 illustrating a second kind of impact between a vertical boom arm and an obstruction during a wash process and continuance of the wash process after the impact.

FIGS. 5A through 5D are top plan views of the automatic vehicle wash system of FIG. 1 illustrating a third kind of impact between a vertical boom arm and an obstruction during a wash process and continuance of the wash process after the impact.

FIGS. 6A through 6D are top plan views of the automatic vehicle wash system of FIG. 1 illustrating a fourth kind of impact between a vertical boom arm and an obstruction during a wash process and continuance of the wash process after the impact.

FIG. 7 is a flow chart illustrating a method of handling vertical boom arm impact in an automatic vehicle wash.

FIG. 8A is a close-up fragmentary isometric view, with parts removed for clarity, of a first embodiment of a flexible vertical boom arm attachment assembly that may be utilized in the system of FIG. 1 in accordance with the present disclosure.

FIG. 8B is a top plan view of the flexible vertical boom arm attachment assembly of FIG. 8A.

FIG. 8C is a bottom plan view of the flexible vertical boom arm attachment assembly of FIG. 8A.

FIG. 8D is an enlarged fragmentary isometric view of the flexible vertical boom arm attachment assembly of FIG. 8A with parts removed for clarity.

FIG. 8E is a view similar to FIG. 8D with the motor mount plate rotating in a first direction.

FIG. 8F is a view similar to FIG. 8D with the motor mount plate rotating in a second direction.

FIG. 9A is a close-up fragmentary isometric view, with parts removed for clarity, of a second embodiment of a flexible vertical boom arm attachment assembly that may be utilized in the system of FIG. 1 in accordance with the present disclosure.

FIG. 9B is a top plan view of the flexible vertical boom arm attachment assembly of FIG. 9A.

FIG. 9C is a bottom plan view of the flexible vertical boom arm attachment assembly of FIG. 9A.

FIG. 9D is an enlarged fragmentary isometric view of the flexible vertical boom arm attachment assembly of FIG. 9A with portions of the trolley cut away for clarity.

FIG. 9E is a view similar to FIG. 9B with illustrating motion of the impact target plate toward the L-shaped sensor member in a first direction.

FIG. 9F is a view similar to FIG. 9B with illustrating motion of the impact target plate toward the L-shaped sensor member in a second direction.

FIG. 10 is block diagram of an exemplary control unit that may be utilized in the system of FIG. 1 in accordance with the present disclosure.

FIG. 11 is a fragmentary, isometric view, with parts removed for clarity, of an exemplary vertical boom arm assembly with a breakaway mechanism assembly.

FIG. 12 is an enlarged reverse view of the exemplary breakaway mechanism assembly of FIG. 11 as indicated in FIG. 11.

FIG. 13 is an enlarged view of the exemplary breakaway mechanism assembly of FIG. 11 as indicated in FIG. 11 in an operational state.

FIG. 14 is an enlarged view in partial cross section and cutaway of the exemplary breakaway mechanism assembly of FIG. 11 in an operational state detailing a ball detent breakaway structure.

FIG. 15A is an isometric view of an exemplary ball detent mechanism for use in a breakaway mechanism assembly for an auto wash boom arm.

FIG. 15B is an exploded view of the ball detent mechanism of FIG. 15A.

FIG. 15C is a top plan view of the ball detent mechanism of FIG. 15A.

FIG. 15D is an elevation view in cross section of the ball detent mechanism of FIG. 15A as indicated in FIG. 15C.

FIG. 16 is an enlarged view of the exemplary breakaway mechanism assembly of FIG. 11 in a dislocated state after encountering an obstacle exerting a force parallel to a side of the vehicle.

FIG. 17 is an enlarged view of the exemplary breakaway mechanism assembly of FIG. 11 in a dislocated state after encountering an obstacle exerting a force directed away from a side of the vehicle.

FIG. 18 is an enlarged view of the exemplary breakaway mechanism assembly of FIG. 11 in an operational state after encountering an obstacle exerting a force directed toward a side of the vehicle.

### DETAILED DESCRIPTION

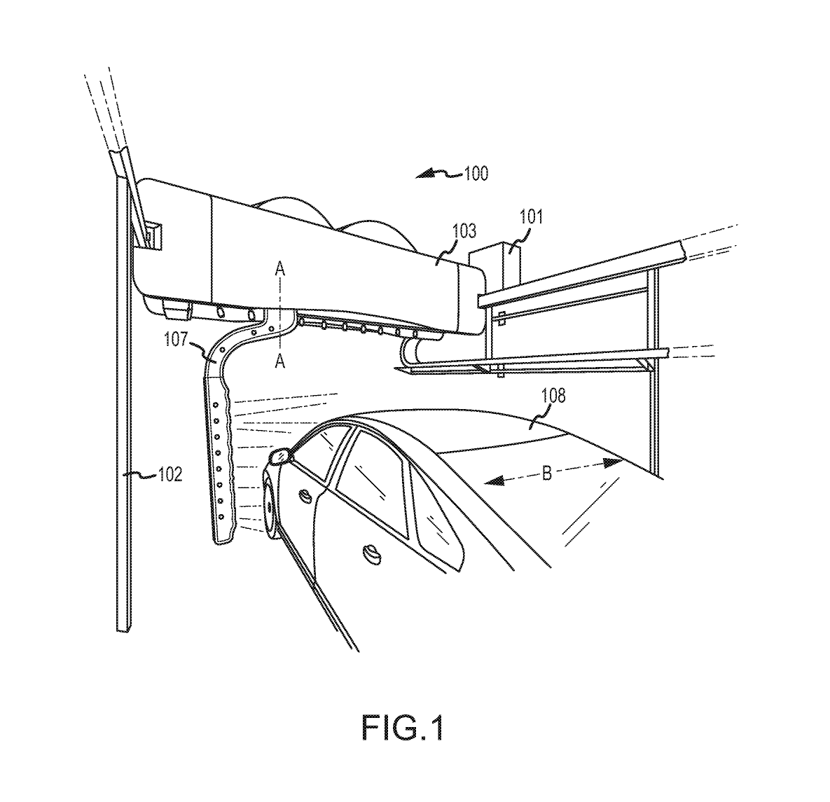

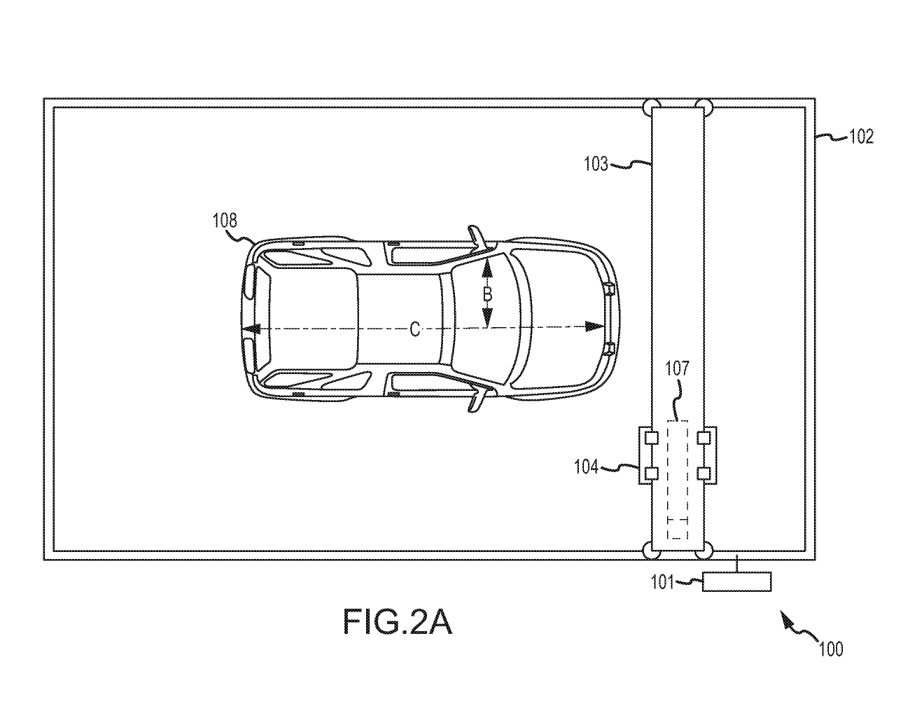

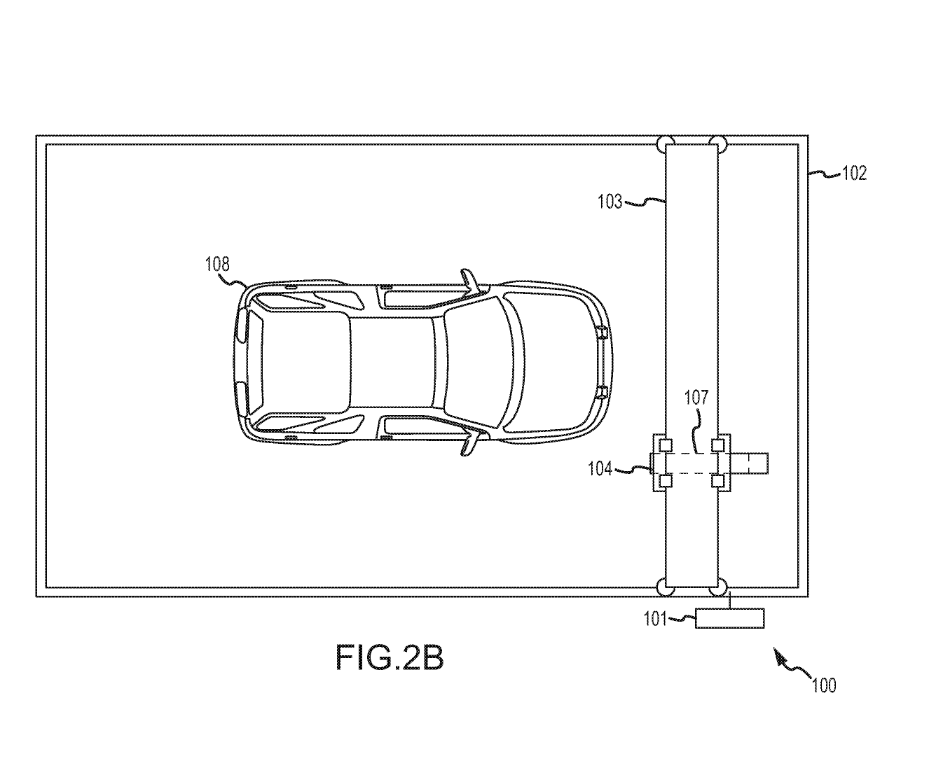

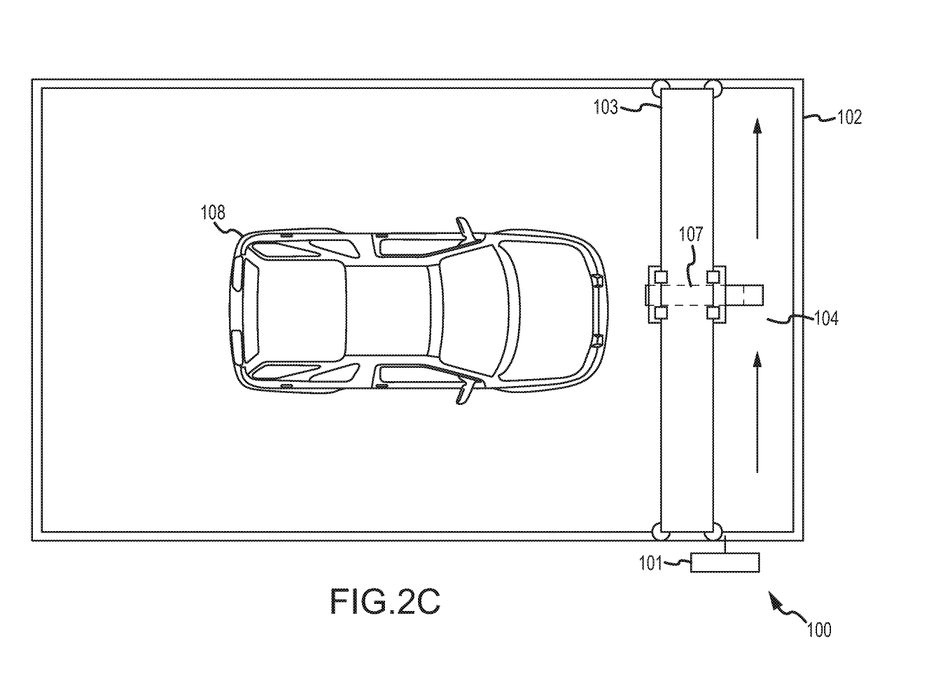

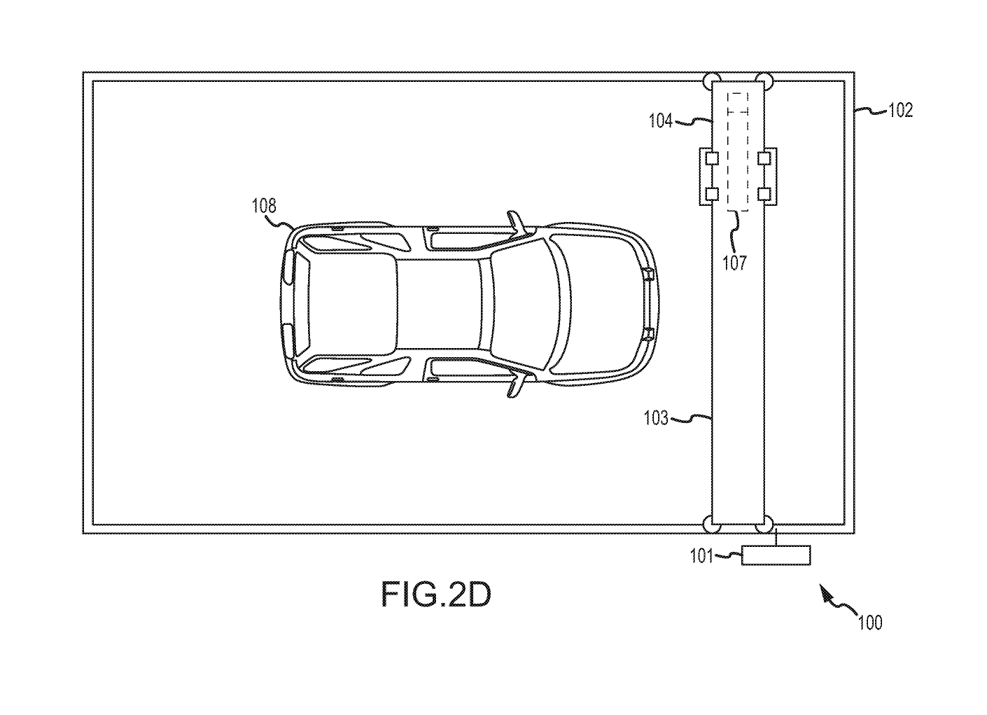

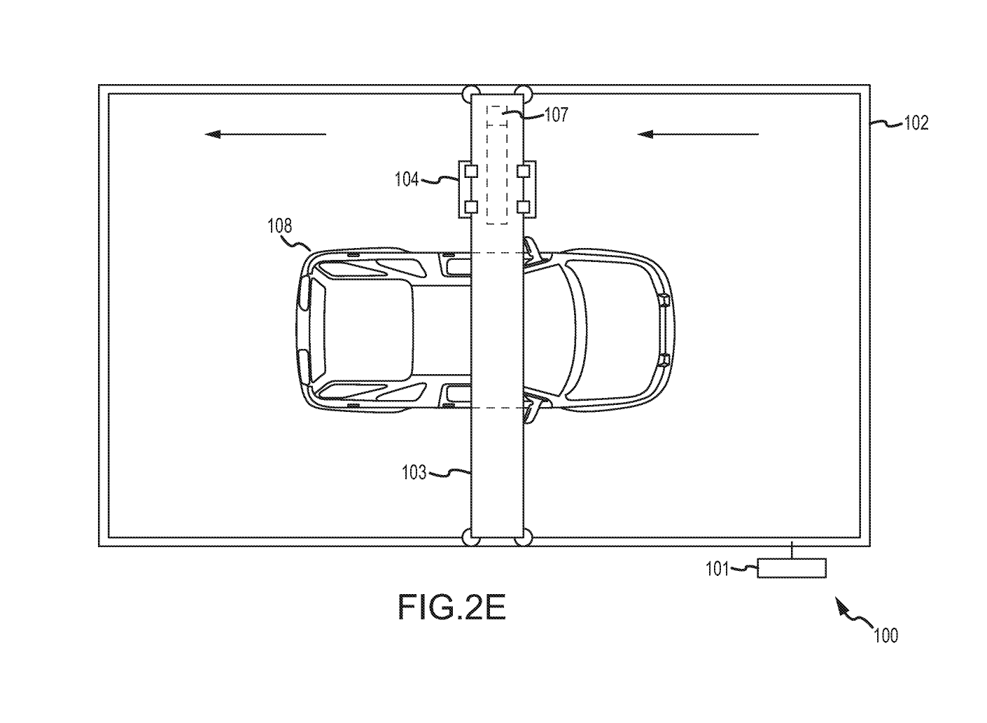

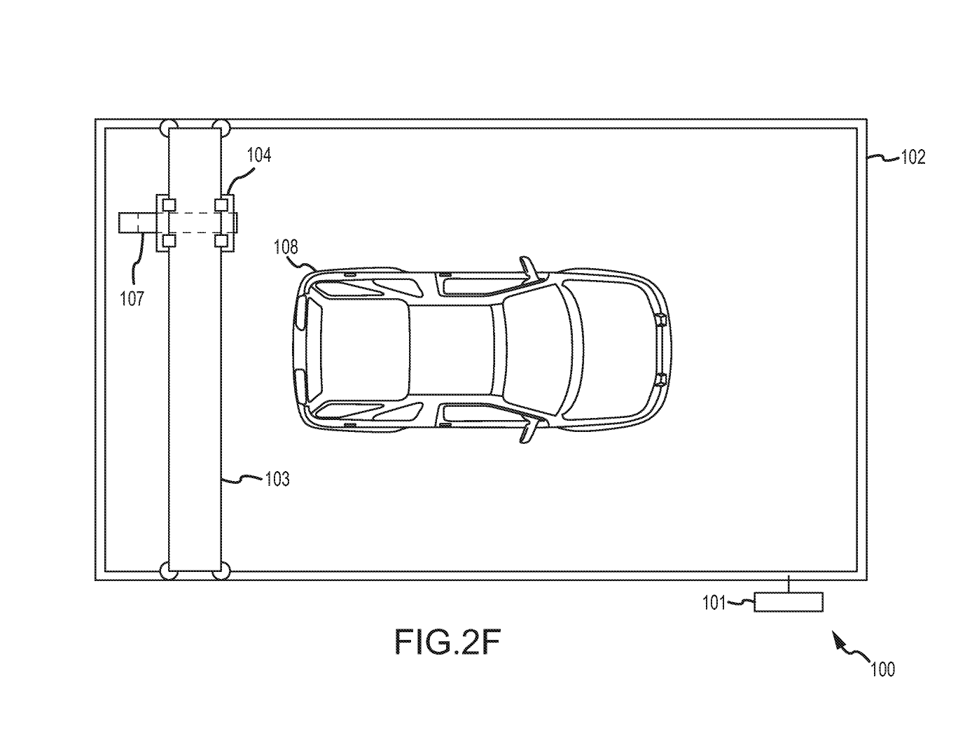

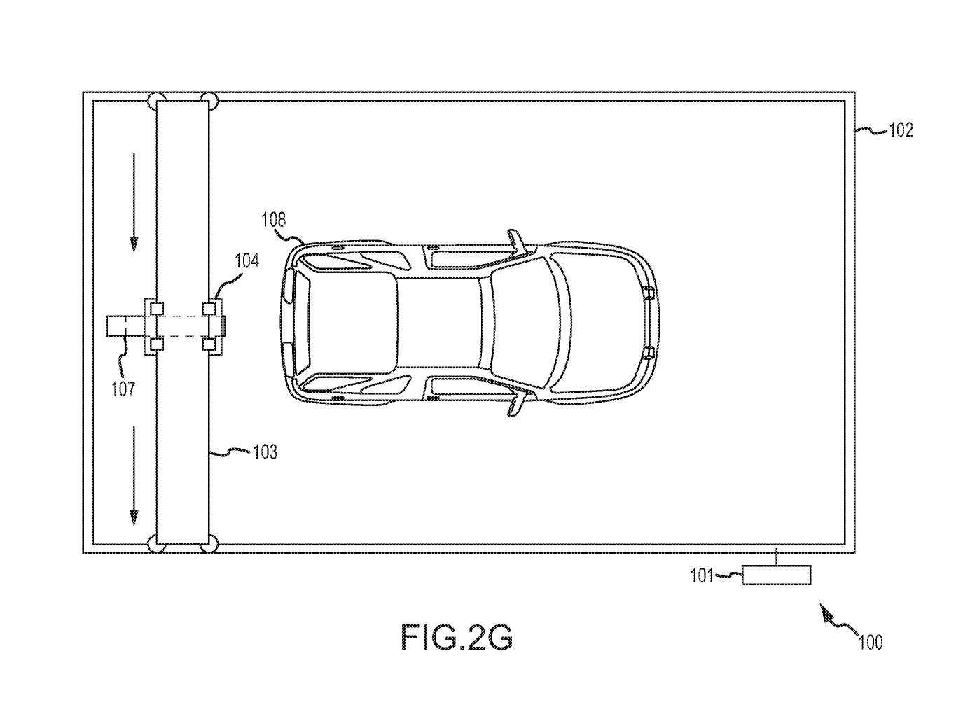

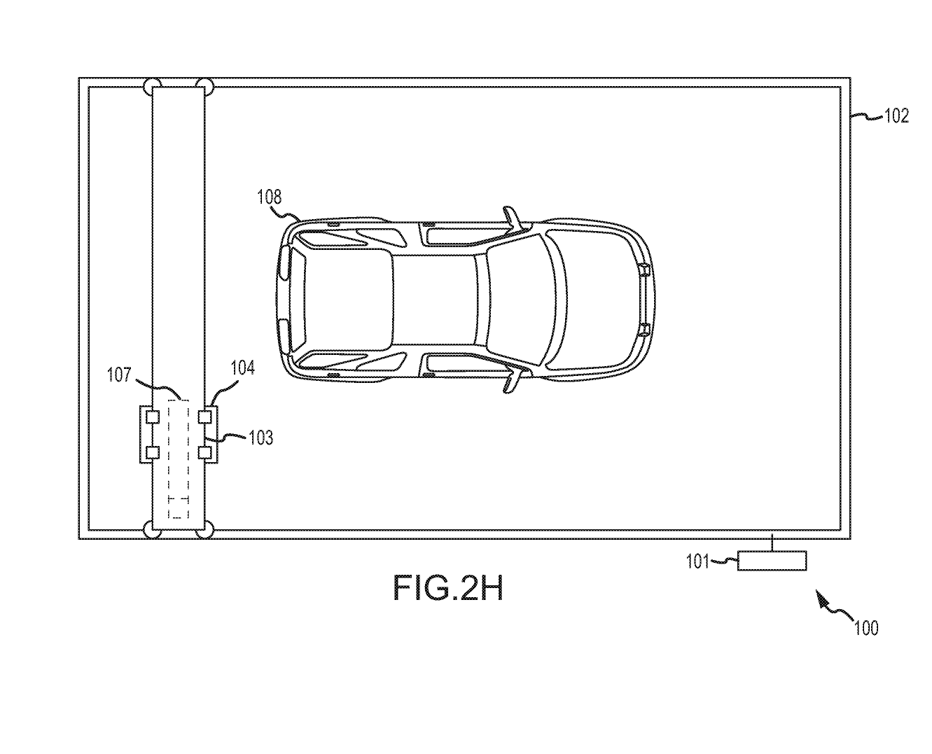

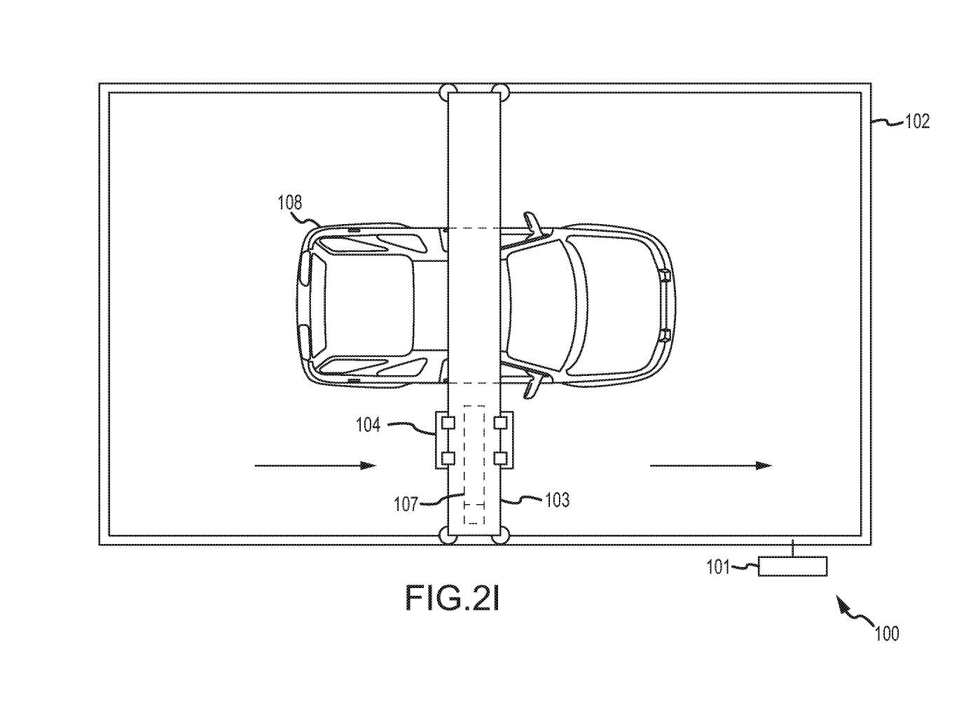

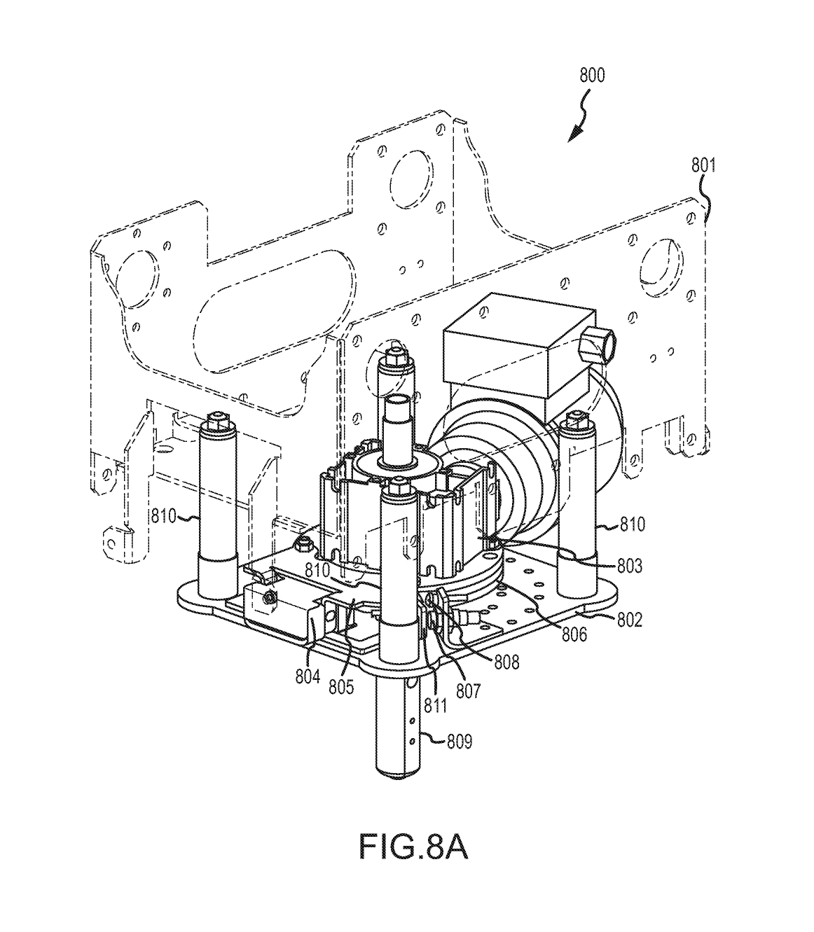

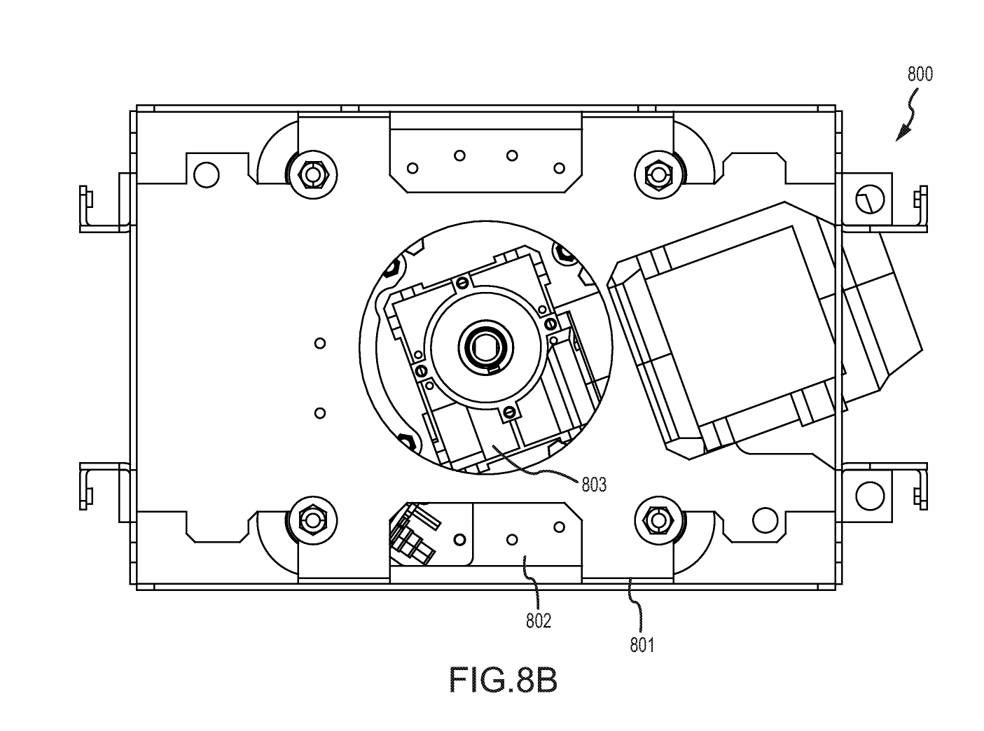

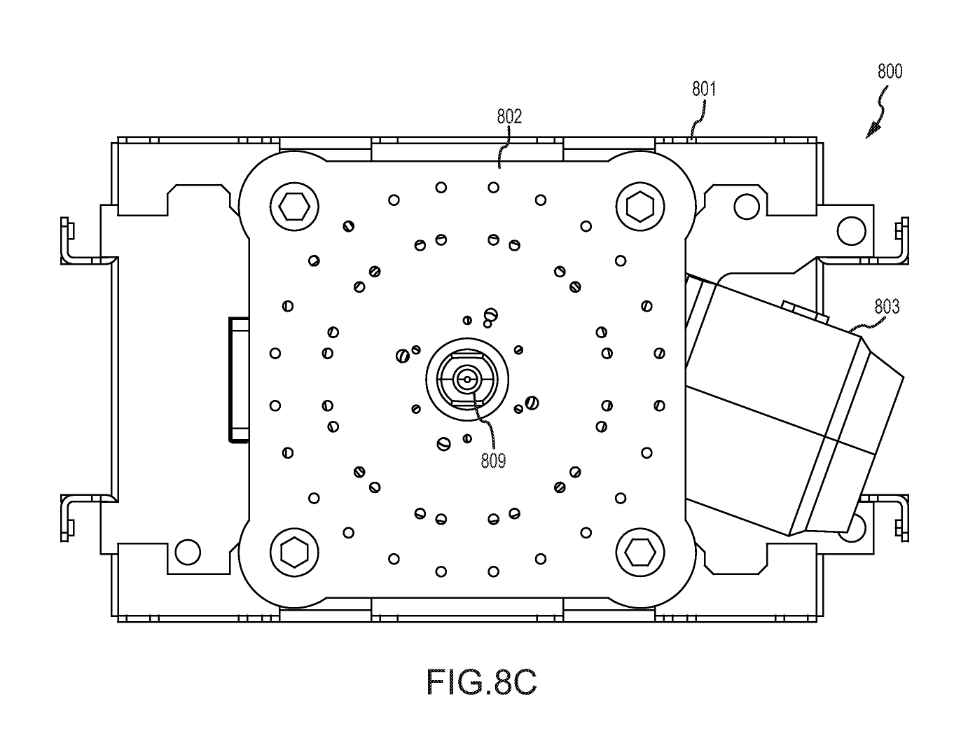

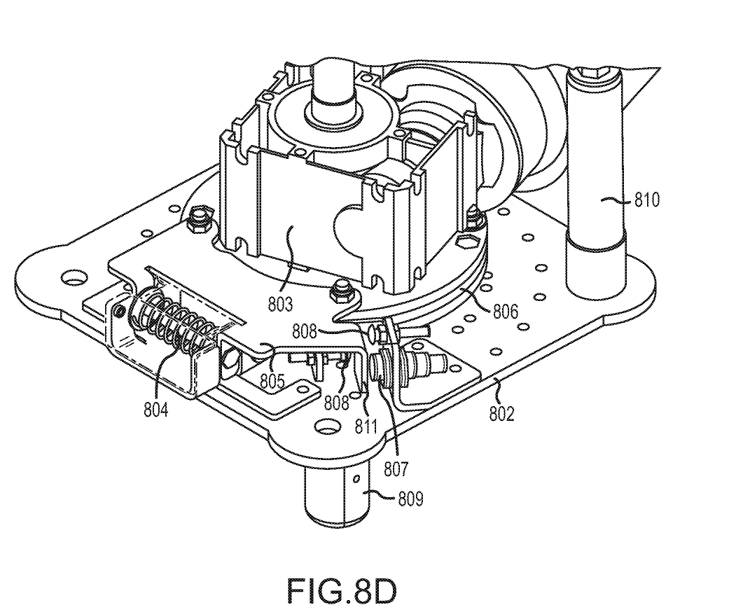

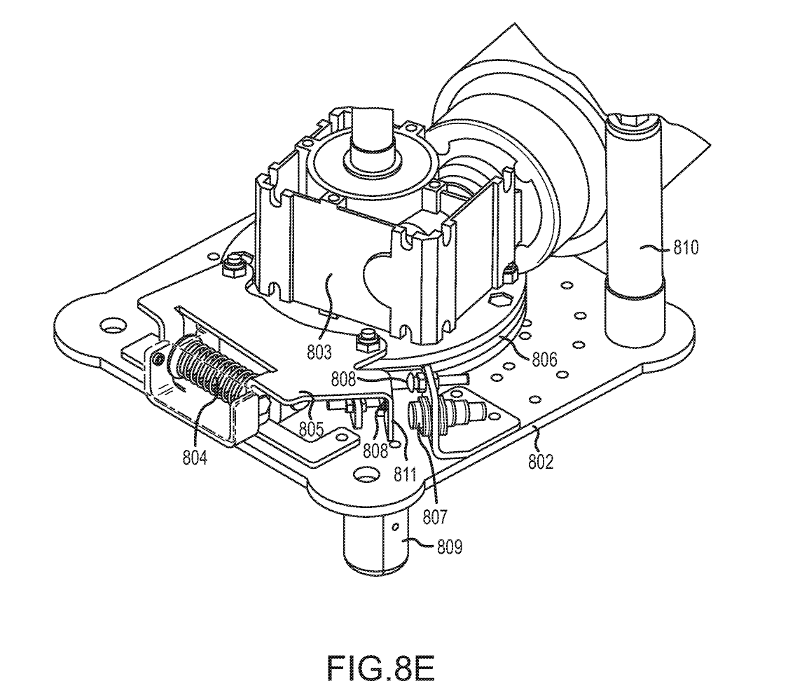

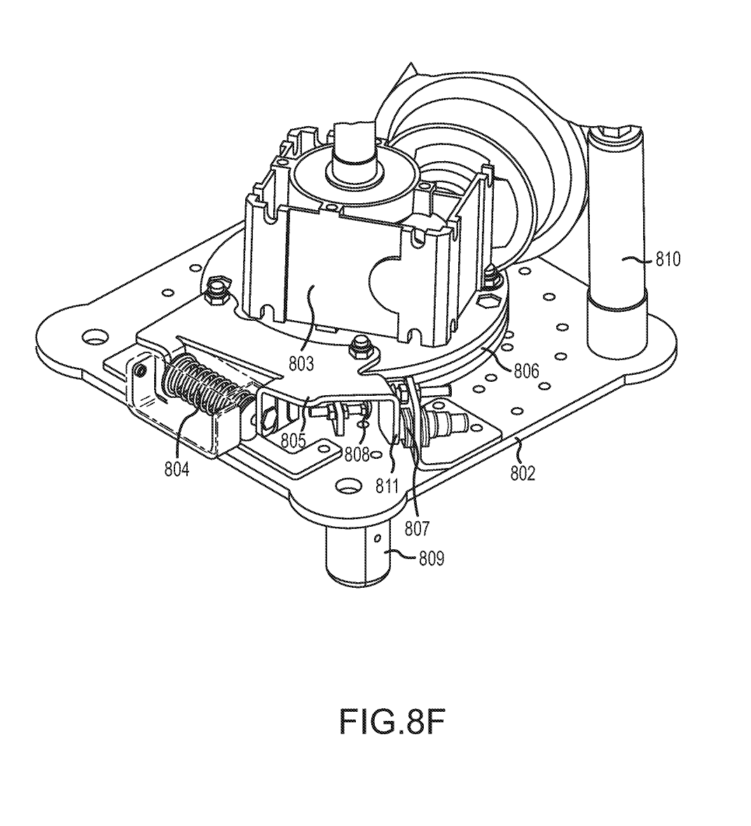

FIGS. 1 and 2A illustrate an automatic car wash system 100 in accordance with the present disclosure. As illustrated, the system 100 includes a frame 102 that is operable to define a wash bay around the perimeter of a vehicle 108. The frame 102 includes a bridge 103 that is operable by a control unit 101 to reciprocate (for example, by an assembly of one or more motors, wheels, tracks, and so on) on the frame 102 along a orientation C (shown in FIG. 2A) that is lengthwise with respect to the vehicle 108. The system 100 also includes a trolley 104 that is operable by a control unit 101 to reciprocate (for example, by an assembly of one or more motors, wheels, tracks, and so on) on the bridge 103 along a orientation B (shown in FIGS. 1 and 2A) that is widthwise with respect to the vehicle 108. Further, as shown in FIGS. 8A-8F, the system 100 includes a motor mount plate 806, flexibly coupled to the trolley 104, that is rotatably coupled to a vertical boom arm 107 via a vertical boom arm shaft 809. Utilizing a motor 803 coupled to the motor mount plate 806 and the vertical boom arm shaft 809, the control unit 101 is operable to rotate the vertical boom arm 107 circularly around the trolley 104 on an axis A (shown in FIG. 1).

FIGS. 2A through 2I illustrate an exemplary wash process performed by the system 100 where an impact does not occur between the vertical boom arm 107 and the vehicle 108. During the wash process, the vertical boom arm 107 may be operable to spray the vehicle 108 with one or more pre-soak solutions, high pressure and/or low pressure rinses, wax solutions, pre-wax solutions, and so on. Further, the system 100 may include other spray mechanisms, for example, nozzles mounted on the bridge 102, in addition to the vertical boom arm 107, which may be operable to spray one or more pre-soak solutions, high pressure and/or low pressure rinses, wax solutions, pre-wax solutions, and so on.

FIG. 2A illustrates the system 100 with the bridge 103, the trolley 104, and the vertical boom arm 107 located at a home position. The control unit 101 may be operable to locate the bridge 103, the trolley 104, and the vertical boom arm 107 in the home position when the wash process is not occurring. As illustrated, in the home position the vertical boom arm 107 is positioned parallel to the orientation B. At the commencement of the wash process, the control unit 101 may rotate the vertical boom arm 107 such that it is parallel to the orientation C, as shown in FIG. 2B. The control unit 101 may then move the trolley 104 on the bridge 103 along the orientation B while spraying the vehicle 108 utilizing the vertical boom arm 107, as shown in FIG. 2C.

As shown in FIG. 2D, when the limit of the assumed front perimeter is reached (at an assumed driver side perimeter location of the vehicle 108), the control unit 101 may then cease movement of the trolley 104 and rotate the vertical boom arm 107 such that it is parallel to the orientation B. The control unit may then move the frame 102 along the orientation C while spraying the vehicle 108 utilizing the vertical boom arm 107, as shown in FIG. 2E.

As shown in FIG. 2F, when the limit of the assumed driver side perimeter is reached (at an assumed back perimeter location of the vehicle 108), the control unit 101 may then cease movement of the bridge 103 and rotate the vertical boom arm 107 such that it is parallel to the orientation C. The control unit may then move the trolley 104 on the bridge 103 along the orientation B while spraying the vehicle 108 utilizing the vertical boom arm 107, as shown in FIG. 2G.

As shown in FIG. 2H, when the limit of the assumed back perimeter is reached (at an assumed passenger side perimeter location of the vehicle 108), the control unit 101 may then cease movement of the trolley 104 and rotate the vertical boom arm 107 such that it is parallel to the orientation B. The control unit may then move the frame 102 along the orientation C while spraying the vehicle 108 utilizing the vertical boom arm 107, as shown in FIG. 2I.

When the limit of the assumed passenger side perimeter is reached (at the assumed front perimeter location of the vehicle 108), the control unit 101 may then return the bridge 103, trolley 104, and vertical boom arm 107 to the home location, as shown in FIG. 2A. Although the above describes the vertical boom arm 107 traveling in a single complete counter-clockwise path around the assumed perimeter of the vehicle 108, other patterns are possible without departing from the scope of the present disclosure. For example, the vertical boom arm 107 may travel in a clockwise pattern, travel multiple times around the assumed perimeter of the vehicle, travel part of the way around the assumed perimeter of the vehicle 108 counter-clockwise and then reverse and travel the rest of the way around the assumed perimeter of the vehicle 108 clockwise, travel part of the way around the assumed perimeter of the vehicle 108 clockwise and then reverse and travel the rest of the way around the assumed perimeter of the vehicle 108 counter-clockwise, and so on.

Further, the control unit 101 may be operable to receive data from one or more sensors during the wash process indicating that an impact may have occurred between the vertical boom arm 107 and the vehicle 108. The motor mount plate 806 may be flexibly attached to the trolley 104, for example, by a rotational bearing assembly, a spring assembly, a rubber mount, and so on. If an impact occurs during the wash process between the vertical boom arm 107 and the vehicle 108, the impact may transfer from the vertical boom arm 107 (via the vertical boom arm shaft 809) to the motor mount plate 806, resulting in a displacement between the trolley 104 and the motor mount plate 806. In some implementations, the displacement may be a two-dimensional (along x and y planes) displacement. In other implementations, the displacement may be an angular displacement. The one or more sensors may be operable to measure the resulting displacement and/or a displacement velocity between the motor mount plate 806 and the trolley 104 and transmit the measurements to the control unit 101. In the case of rotational displacement, the resulting displacement between the motor mount plate 806 and the lower trolley mount plate 802 is measured. The motor mount plate 806 and the lower trolley mount plate 802 may be separated by a bearing that allows rotation between the two.

Further, during the wash process, some displacement between the trolley 104 and the motor mount plate 806 may be caused by occurrences other than impact between the vertical boom arm 107 and the vehicle 108. For example, such displacement may be caused by the movement of the bridge 103, the movement of the trolley 104, the rotation of the vertical boom arm 107, the thrust of the spray from the vertical boom arm 107, and so on. To account for such non-impact related displacement, the control unit 101 may compare data received from the one or more sensors to a baseline. The control unit 101 may determine an impact occurred if the data meets and/or exceeds the baseline. Contrarily, the control unit 101 may determine an impact has not occurred if the data does not meet and/or exceed the baseline. The baseline may include information on displacement during the wash process attributable to the movement of the bridge 103, the movement of the trolley 104, the rotation of the vertical boom arm 107, the thrust of the spray from the vertical boom arm 107, and so on. In some implementations, the baseline may be created by measuring data from the one or more sensors during a wash process when an impact did not occur.

Moreover, the control unit 101 may compare the data received from the one or more sensors to different baselines depending on the quadrant of the wash bay (for example, the front of the vehicle 108, the drivers side of the vehicle 108, the back of the vehicle 108, and the passenger side of the vehicle 108) that the vertical boom arm 107 is located in. For example, the thrust of the spray from the vertical boom arm 107 may result in displacement in a different direction for each of the quadrants as the spray is in a different direction. The baseline utilized by the control unit 101 for each of the quadrants may reflect this difference, allowing the control unit 101 to weight displacement from the associated direction of the spray thrust less than displacement from other directions. By way of another example, an impact between the vertical boom arm 107 and the vehicle 108 may result in displacement in a different direction for each of the quadrants as the vertical boom arm 107 travels in a different direction. The baseline utilized by the control unit 101 for each of the quadrants may reflect this difference, allowing the control unit 101 to weight displacement from the associated direction of travel more than other directions.

If the control unit 101 determines that an impact has occurred during the wash process between the vertical boom arm 107 and the vehicle, the control unit 101 may relocate the vertical boom arm 107 (such as by moving the bridge 103, moving the trolley 104, rotating the vertical boom arm 107, and so on). In some implementations, the control unit 101 may relocate the vertical boom arm 107 and perform operations to continue the wash process after the relocation. The operations the control unit 101 may perform to continue the wash process may depend on the quadrant the vertical boom arm 107 was located in when the control unit 101 determined an impact occurred.

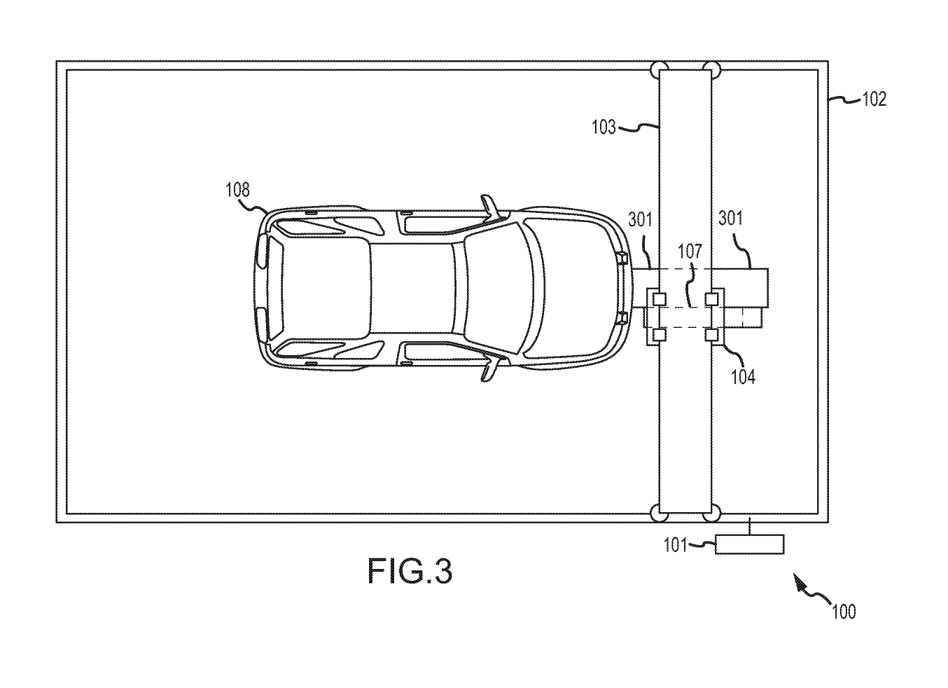

By way of a first example, FIG. 3 illustrates an impact between the vertical boom arm 107 and an obstruction on the front of the vehicle 108. The obstruction may be any kind of obstruction on the front of the vehicle such as a winch mounted on the front of the vehicle 108, a ramming plate mounted on the front of the vehicle 108, a bike and/or ski rack mounted on the front of the vehicle 108, an irregular bumper of the vehicle 108, a spare tire mounted on the front of the vehicle 108, and so on. Regardless of the type of obstruction, the actual front perimeter of the vehicle 108 exceeds the assumed front perimeter. As illustrated, in this example the obstruction is a winch 301 mounted on the front of the vehicle 108. When the control unit 101 determines that the impact illustrated in FIG. 3 has occurred, the control unit 101 may stop movement of the trolley 104 and may return the bridge 103, trolley 104, and vertical boom arm 107 to the home position shown in FIG. 2A. The control unit 101 may return the bridge 103, trolley 104, and vertical boom arm 107 to the home position as the system 100 may not be capable of moving the bridge 103, trolley 104, and vertical boom arm 107 sufficiently away from the front of the vehicle 108 to continue the wash process utilizing the vertical boom arm 107. In implementations where the system 100 is capable of moving the bridge 103, trolley 104, and vertical boom arm 107 sufficiently away from the front of the vehicle 108, the control unit 101 may move the bridge 103, trolley 104, and vertical boom arm 107 to a new assumed front perimeter and continue the wash process utilizing the vertical boom arm 107. In some implementations of this example, if the system 100 includes other spray mechanisms (for example, nozzles mounted on the bridge 103 and so on) in addition to the vertical boom arm 107, the control unit 101 may then continue the wash process utilizing the other spray mechanisms and/or perform a single rinse pass. In other implementations of this example, the control unit 101 may then terminate the wash process.

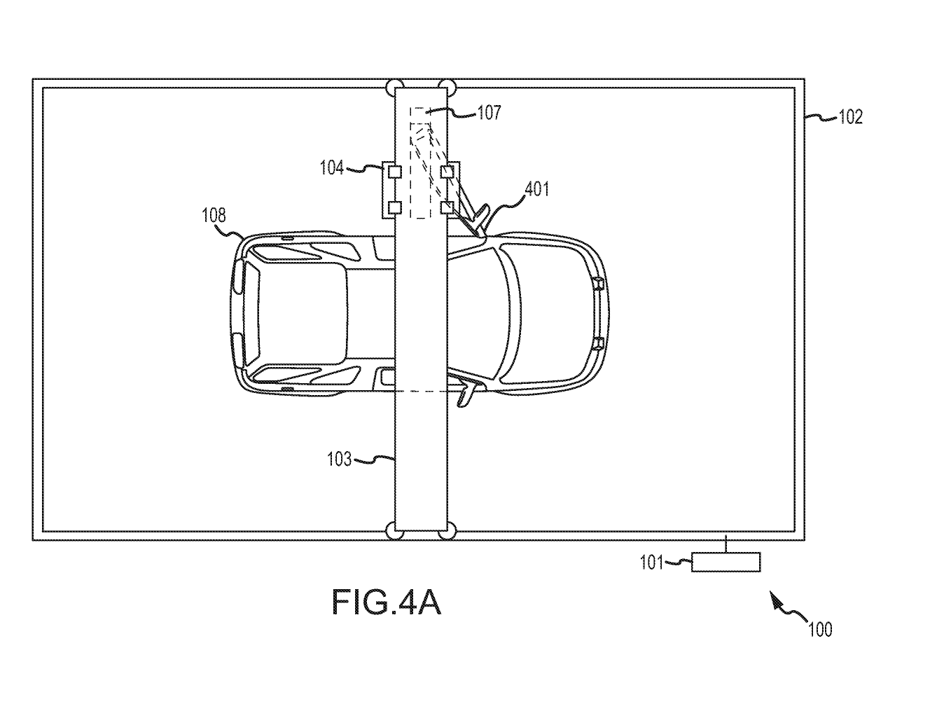

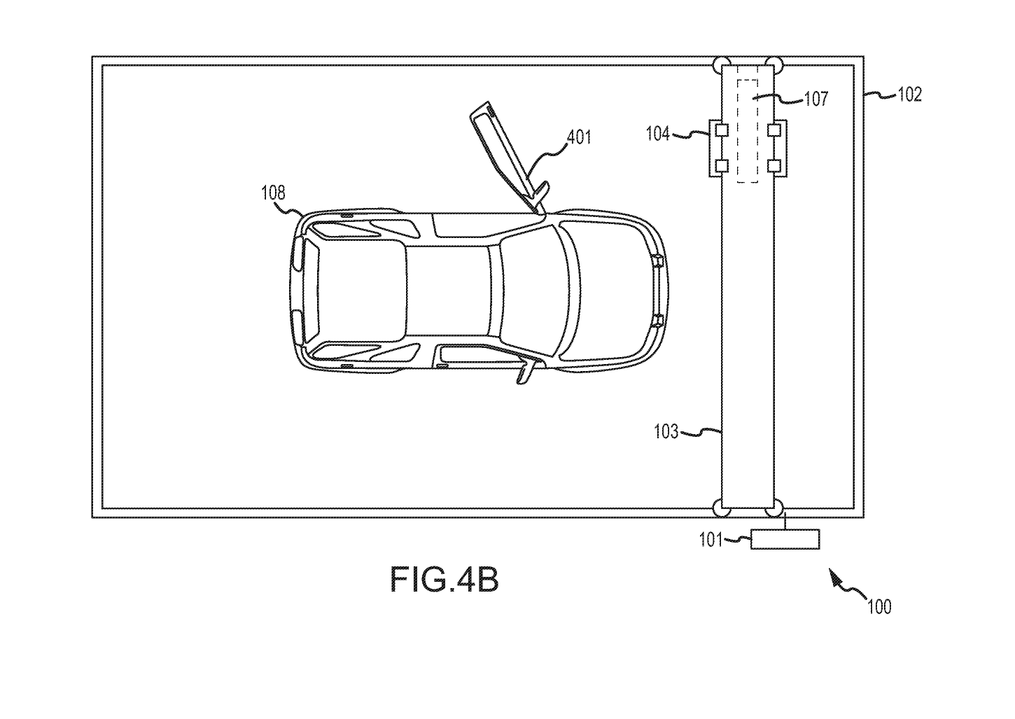

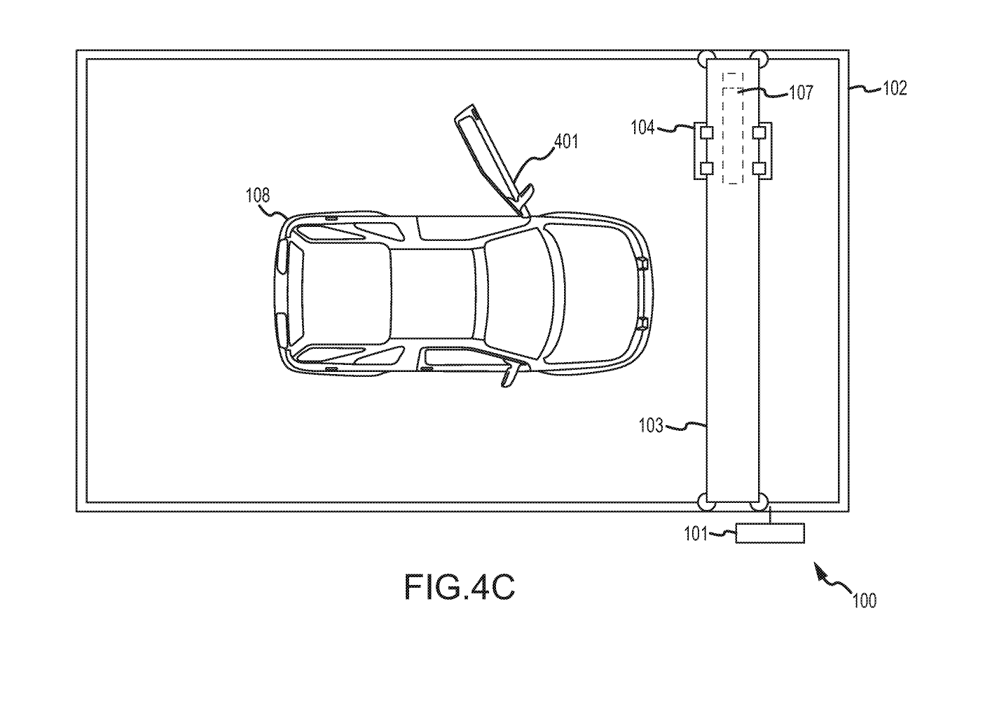

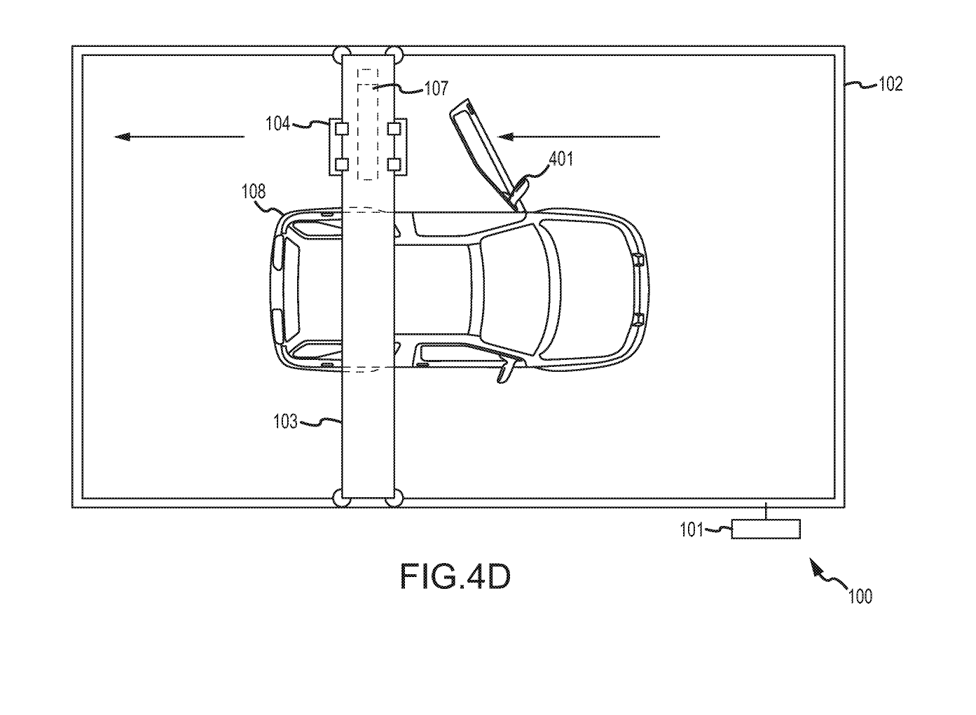

In a second example, FIG. 4A illustrates an impact between the vertical boom arm 107 and an obstruction on the driver side of the vehicle 108. The obstruction may be any kind of obstruction on the driver side of the vehicle such as a bike and/or ski rack mounted on the driver side of the vehicle 108, a side mirror, an open door, a spare tire mounted on the driver side of the vehicle 108, and so on. Regardless of the type of obstruction, the actual driver side perimeter of the vehicle 108 exceeds the assumed driver side perimeter. As illustrated, in this example the obstruction is an open driver side door 401 of the vehicle 108. When the control unit 101 determines that the impact illustrated in FIG. 4A has occurred, the control unit 101 may stop movement of the bridge 103. The control unit 101 may then move the bridge 103 in the opposite direction from the impact and move the trolley 104 to its farthest possible position on the bridge 103 along the orientation B away from the vehicle 108, as illustrated in FIG. 4B. Next, the control unit 101 may move the trolley 104 partway back on the bridge 103 along the orientation B toward the vehicle 108 to a new assumed driver side perimeter, as illustrated in FIG. 4C. The control unit 101 may then resume the wash process by moving the bridge 103 on the frame 102 along the orientation C utilizing the new assumed driver side perimeter, as illustrated in FIG. 4D. Although the present example describes the control unit 101 as moving the trolley 104 to its farthest possible position on the bridge 103 away from the vehicle 108 and then moving the trolley 104 partway back on the bridge 103 toward the vehicle 108 to a new assumed driver side perimeter, in other examples the control unit 101 may move the trolley 104 on the bridge 103 away from the vehicle 108 to the new assumed driver side perimeter without first moving the trolley 104 to its farthest possible position on the bridge 103 away from the vehicle 108.

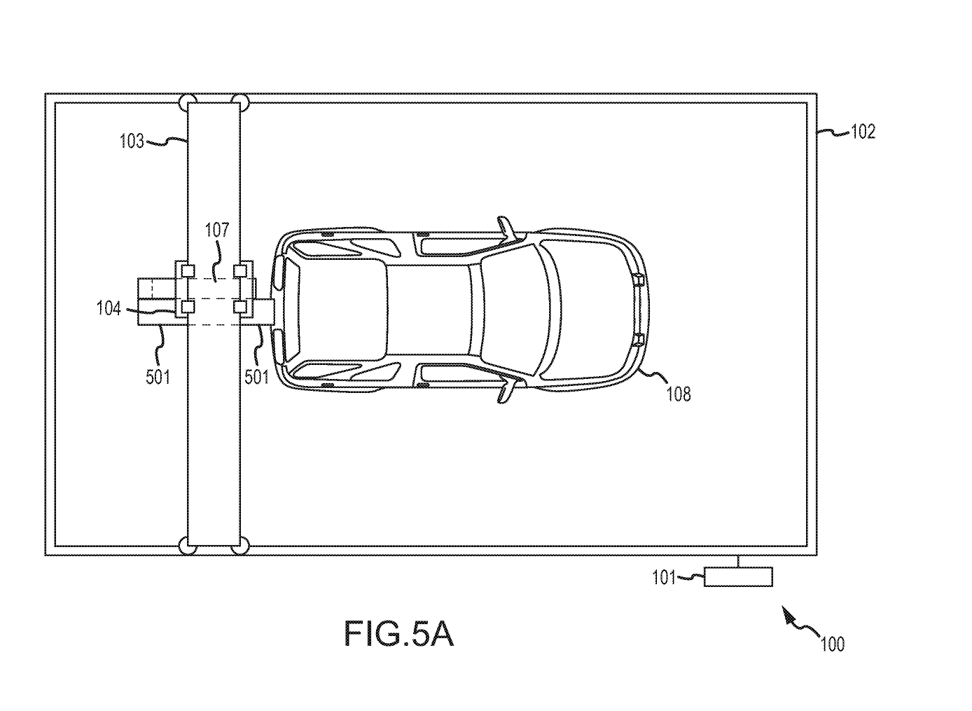

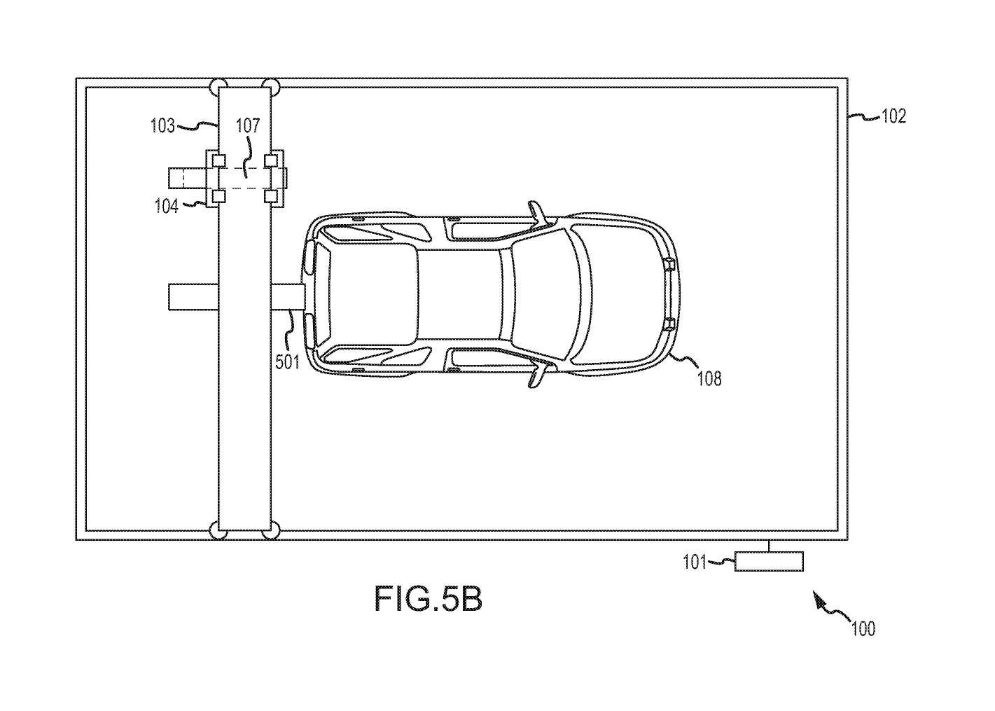

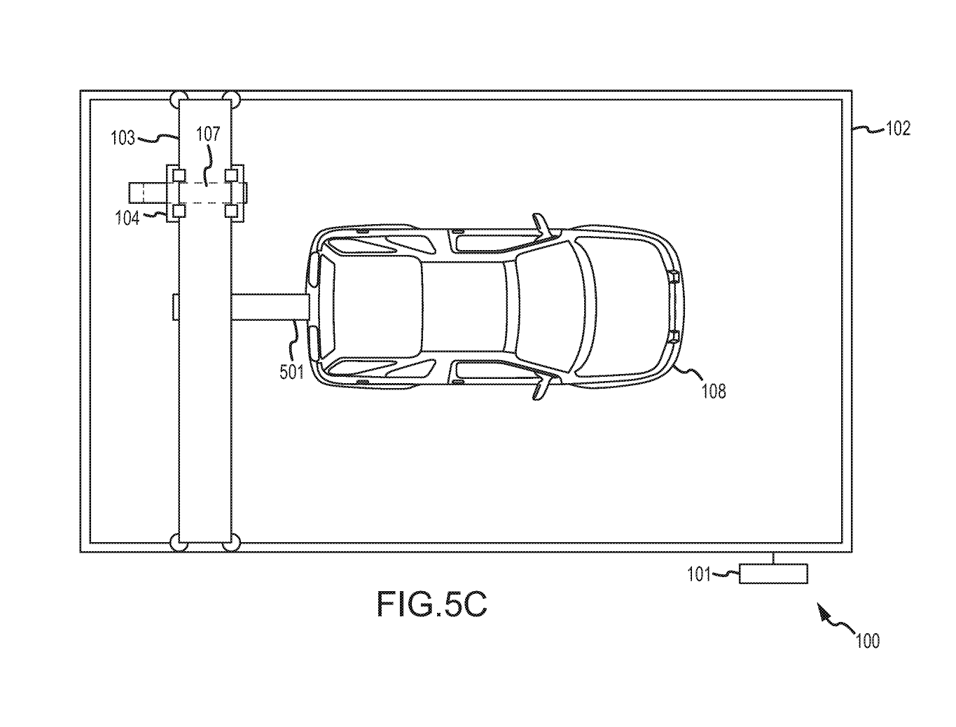

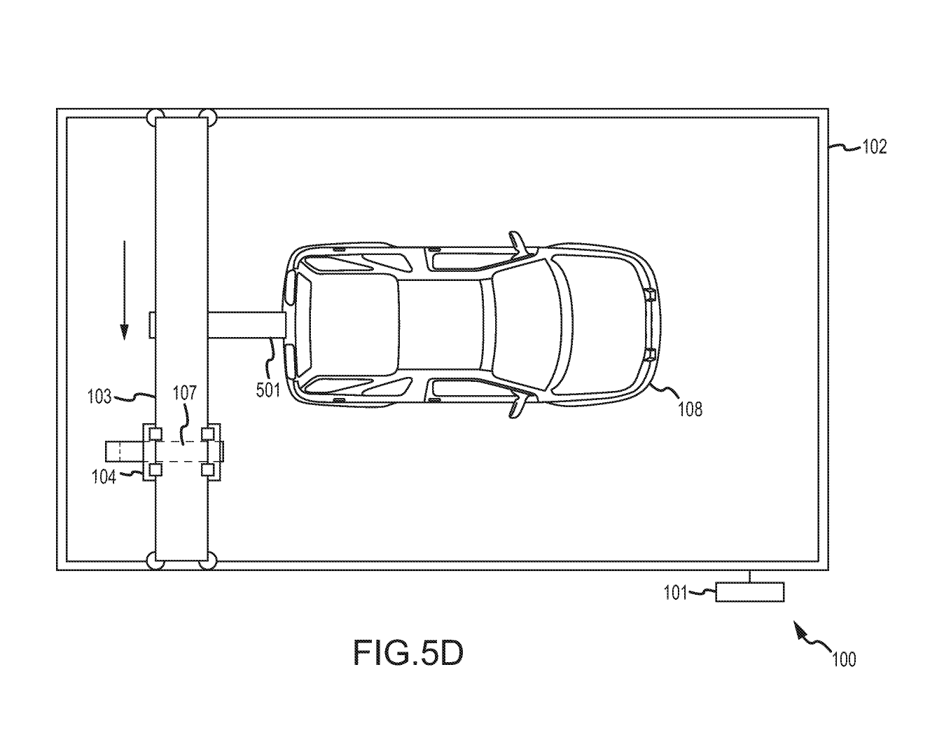

In a third example, FIG. 5A illustrates an impact between the vertical boom arm 107 and an obstruction on the back of the vehicle 108. The obstruction may be any kind of obstruction on the back of the vehicle such as a trailer hitch mounted on the back of the vehicle 108, a bike and/or ski rack mounted on the back of the vehicle 108, an irregular bumper of the vehicle 108, a spare tire mounted on the back of the vehicle 108, and so on. Regardless of the type of obstruction, the actual back perimeter of the vehicle 108 exceeds the assumed back perimeter. As illustrated, in this example the obstruction is spare tire 501 mounted on the back of the vehicle 108. When the control unit 101 determines that the impact illustrated in FIG. 5A has occurred, the control unit 101 may stop movement of the trolley 104 in its current direction and may move the trolley 104 in the opposite direction to its farthest possible position on the bridge 103 along the orientation B away from the vehicle 108, as illustrated in FIG. 5B. Next, the control unit 101 may move the bridge 103 on the track 102 along the orientation C away the vehicle 108 to a new assumed back perimeter, as illustrated in FIG. 5C. The control unit 101 may then resume the wash process by moving the trolley 104 on the bridge 103 along the orientation B utilizing the new assumed back perimeter, as illustrated in FIG. 5D.

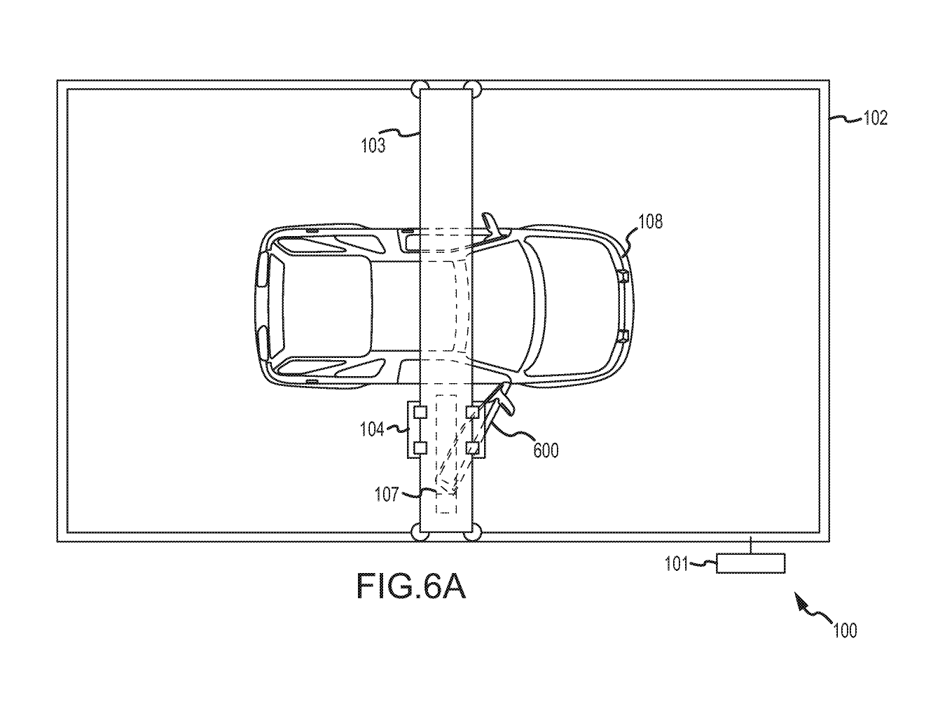

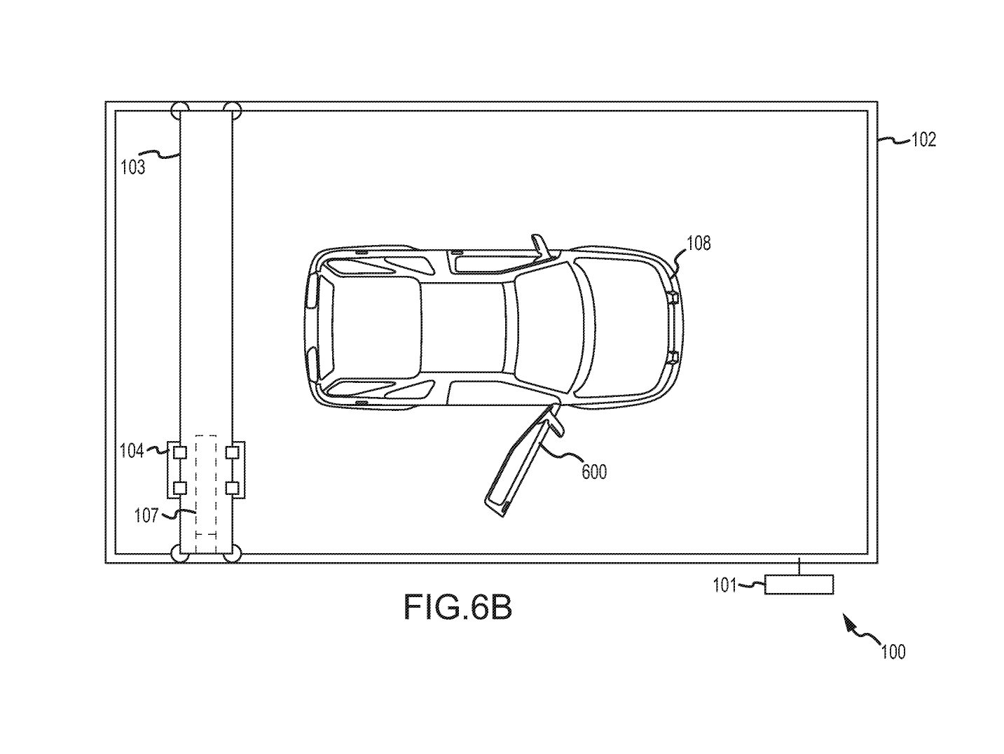

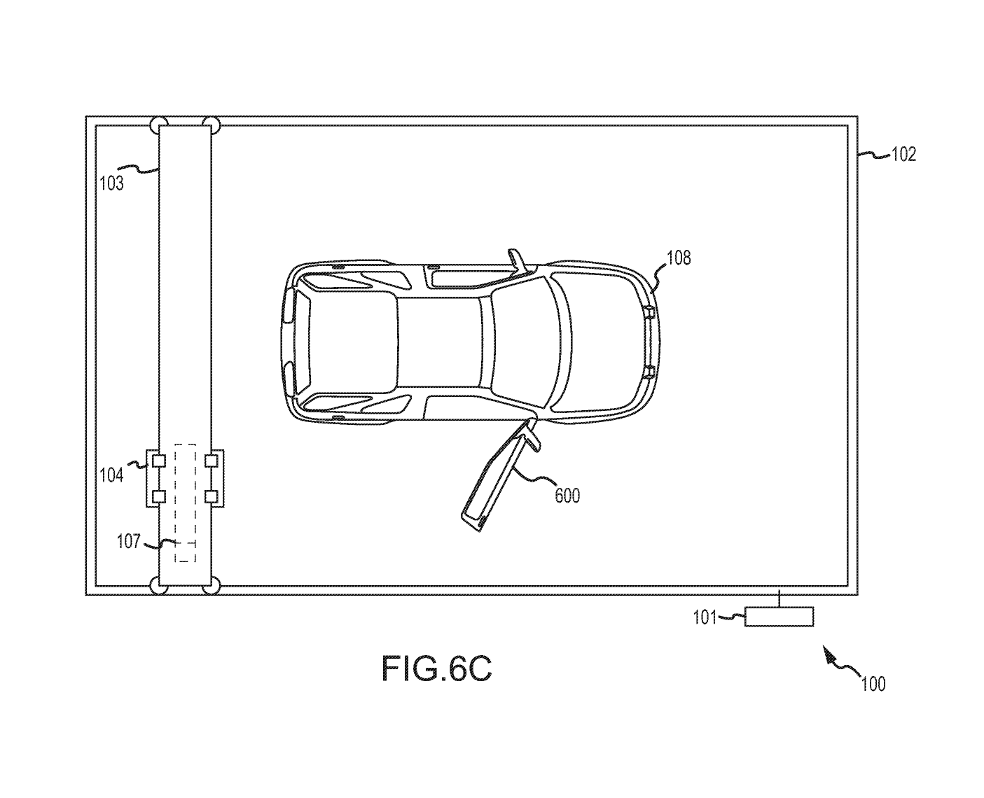

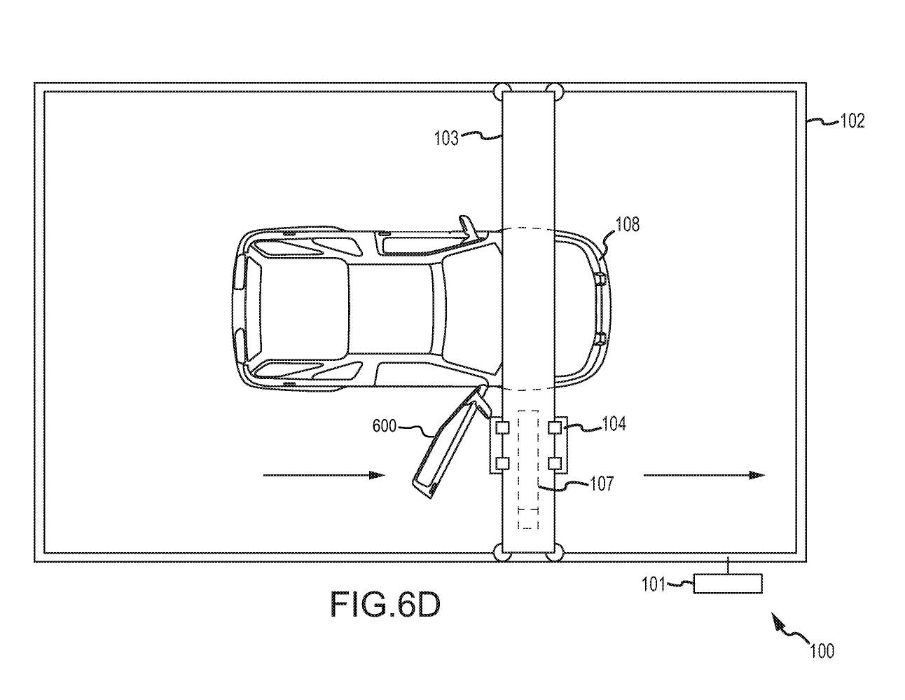

In a fourth example, FIG. 6A illustrates an impact between the vertical boom arm 107 and an obstruction on the passenger side of the vehicle 108. The obstruction may be any kind of obstruction on the passenger side of the vehicle such as a bike and/or ski rack mounted on the passenger side of the vehicle 108, a side mirror, an open door, a spare tire mounted on the passenger side of the vehicle 108, and so on. Regardless of the type of obstruction, the actual passenger side perimeter of the vehicle 108 exceeds the assumed passenger side perimeter. As illustrated, in this example the obstruction is an open right, or passenger, side door 600 of the vehicle 108. When the control unit 101 determines that the impact illustrated in FIG. 6A has occurred, the control unit 101 may stop movement of the bridge 103. The control unit 101 may then move the bridge 103 in the opposite direction from the impact and move the trolley 104 to its farthest possible position on the bridge 103 along the orientation B away from the vehicle 108, as illustrated in FIG. 6B. Next, the control unit 101 may move the trolley 104 partway back on the bridge 103 along the orientation B toward the vehicle 108 to a new assumed passenger side perimeter, as illustrated in FIG. 6C. The control unit 101 may then resume the wash process by moving the bridge 103 on the frame 102 along the orientation C utilizing the new assumed passenger side perimeter, as illustrated in FIG. 6D. Although the present example describes the control unit 101 as moving the trolley 104 to its farthest possible position on the bridge 103 away from the vehicle 108 and then moving the trolley 104 partway back on the bridge 103 toward the vehicle 108 to a new assumed passenger side perimeter, in other examples the control unit 101 may move the trolley 104 on the bridge 103 away from the vehicle 108 to the new assumed passenger side perimeter without first moving the trolley 104 to its farthest possible position on the bridge 103 away from the vehicle 108.

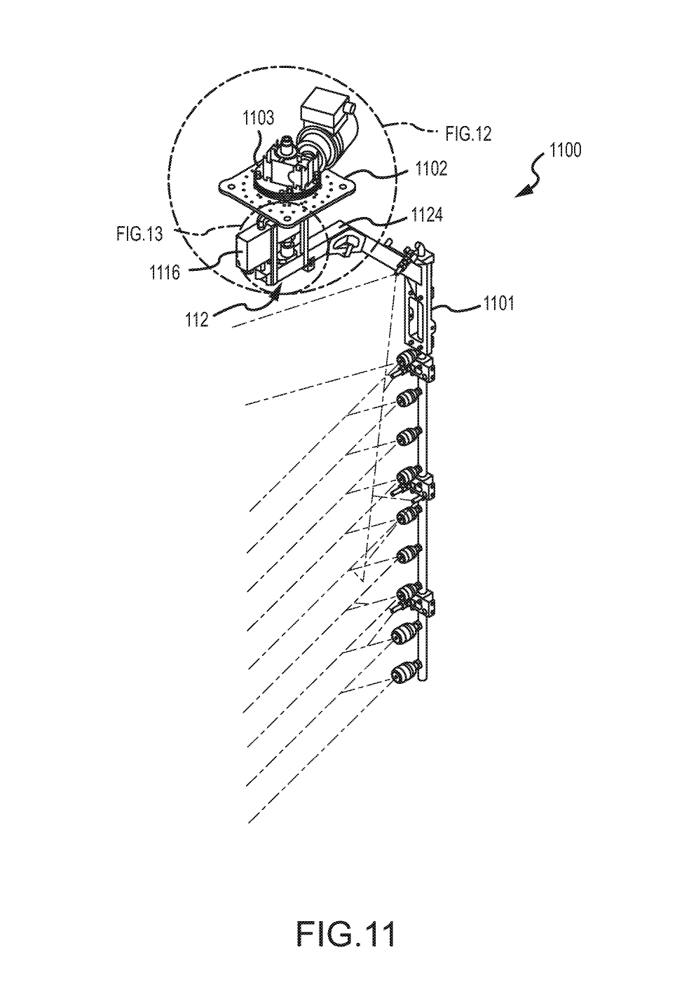

In some implementations, the vertical boom arm 107 may include a breakaway mechanism (see FIG. 11) (for example, a spring loaded ball detent) that is operable to disengage the vertical boom arm 107 when an impact occurs between the vertical boom arm 107 and a vehicle and/or another object that is a greater impact than the control unit 101 has the ability to correct for. In such implementations, the vertical boom arm 107 may include a breakaway target plate assembly and one or more breakaway sensors which detect when a breakaway has occurred by detecting vertical displacement of the breakaway target plate. If the control unit 101 determines that the breakaway sensor has detected a breakaway, the control unit 101 may abandon the current wash and remain dormant until the breakaway mechanism is reset and the automatic vehicle wash 100 is reset.

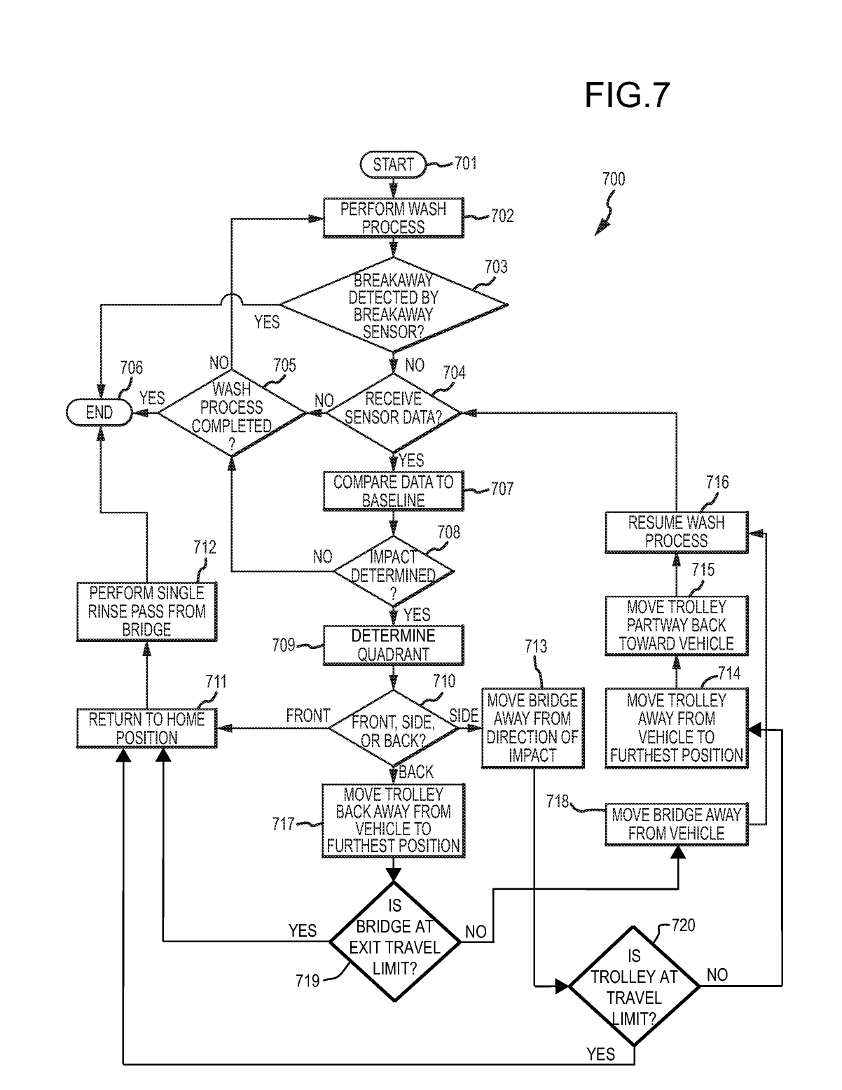

FIG. 7 is a flow chart illustrating a method 700 of handling vertical boom arm impact in an automatic vehicle wash system, which may be performed by the system 100. The method 700 begins at block 701 and proceeds to block 702, where the control unit 101 begins the wash process. From block 702, the flow proceeds to block 703 where the control unit determines whether data from one or more breakaway sensors indicates whether a breakaway mechanism of the vertical boom arm 107 has broken away. If the control unit 101 determines that the breakaway sensor does not indicate that the breakaway mechanism of the vertical boom arm 107 has broken away, the flow proceeds to block 704. Otherwise, the flow proceeds to block 706 and ends.

At block 704, the control unit 101 determines whether data from one or more sensors has been received. If data has not been received, the flow proceeds to block 705. If data has been received, the flow proceeds to block 707.

At block 705, the control unit 101 determines whether the wash process has completed. If the wash process has not completed, the flow returns to block 702. If the wash process has completed, the flow proceeds to block 706 and ends.

At block 707, the control unit 101 compares the data that has been received from the one or more sensors to a baseline and the flow proceeds to block 708. At block 708, the control unit 101 determines, based on the comparison in block 707, whether an impact has occurred. If the control unit 101 determines that an impact has not occurred, the flow proceeds to block 705. If the control unit 101 determines that an impact has occurred, the flow proceeds to block 709.

At block 709, the control unit 101 determines which quadrant the vertical boom arm 107 was in when the impact occurred. As the control unit 101 controls which quadrant the vertical boom arm 107 is in by controlling the motion of the bridge 103, the trolley 104, and the vertical boom arm 107, the control unit 101 may determine the quadrant that the vertical boom arm 107 is in by determining what directions the control unit 101 has issued to the bridge 103, the trolley 104, and the vertical control arm 107. The flow then proceeds to block 710. If the control unit 101 determines that the vertical boom arm 107 is located in the quadrant of the wash bay associated with the front of the vehicle 108, the flow proceeds to block 711. If the control unit 101 determines that the vertical boom arm 107 is located in either the quadrant of the wash bay associated with the driver side of the vehicle 108 or the quadrant of the wash bay associated with the passenger side of the vehicle 108, the flow proceeds to block 713. If the control unit 101 determines that the vertical boom arm 107 is located in the quadrant of the wash bay associated with the back of the vehicle 108, the flow proceeds to block 717.

At block 711, the control unit 101 returns the bridge 103, trolley 104, and the vertical boom arm 107 to a home position and the flow proceeds to block 712. The control unit 101 may return the bridge 103, trolley 104, and vertical boom arm 107 to the home position as the system 100 may not be capable of moving the bridge 103, trolley 104, and vertical boom arm 107 sufficiently away from the front of the vehicle 108 to continue the wash process utilizing the vertical boom arm 107. In implementations where the system 100 is capable of moving the bridge 103, trolley 104, and vertical boom arm 107 sufficiently away from the front of the vehicle 108, the control unit 101 may move the bridge 103, trolley 104, and vertical boom arm 107 to a new assumed front perimeter and continue the wash process utilizing the vertical boom arm 107. At block 712, the control unit 101 performs a single rinse pass of the vehicle 108 utilizing the bridge 103. The flow then proceeds to block 706 and ends.

At block 713, the control unit 101 moves the bridge 103 in the opposite direction of the impact and the flow proceeds to decision block 720. If the trolley 104 is at its travel limit and cannot be moved far enough away to clear the obstruction, then the control unit 101 will return the bridge 103, the trolley 104, and the vertical boom arm 107 to the home position indicated at block 711 via the last known, unobstructed path. This means reversing all the way back to the home position. Alternatively, if the trolley 104 is not at its travel limit, the flow proceeds to block 714. At block 714, the control unit 101 moves the trolley 104 to its furthest position away from the vehicle 108 on the bridge 103 and the flow proceeds to block 715. At block 715, the control unit moves the trolley 104 partway back toward the vehicle 108 on the bridge 103 to a new assumed side perimeter position (corresponding to the side of the vehicle 108 on which the control unit 101 determined the impact occurred) and the flow proceeds to block 716.

At block 717, the control unit 101 moves the trolley 104 in the opposite direction of the impact to its furthest position away from the vehicle 108 on the bridge 103 and the flow proceeds to decision block 719. If the bridge 103 reaches its travel limit at the exit end of the wash bay and is unable to move far enough away to clear the obstruction, then the control unit 101 will return the bridge 103, the trolley 104, and the vertical boom arm 107 to the home position indicated at block 711 via the last known, unobstructed path. This means reversing all the way back to the home position. Alternatively, if the bridge 104 is not at its travel limit on the exit end of the wash bay, the flow proceeds to block 718. At block 718, the control unit moves the bridge 103 away from the vehicle 108 to a new assumed back perimeter position and the flow proceeds to block 716. At block 716, the control unit 101 resumes the wash process and the flow returns to block 704 to await further breakaway sensor data.

FIGS. 8A through 8F illustrate a close-up view of an assembly 800 wherein a motor mount plate 806 is flexibly attached to a trolley 801 that may be utilized in the system 100 according to a first embodiment of the present disclosure. FIG. 8A illustrates an isometric view of the assembly 800, showing the motor mount plate 806 flexibly attached to the trolley 801, removed from the system 100 for clarity. As illustrated, the assembly 800 includes a lower trolley plate 802 that is fixedly attached to the trolley 801 by fixed attachment posts 810. Also as illustrated, the assembly 800 includes the motor mount plate 806 which is flexibly attached to the lower trolley plate 802 via a rotation bearing assembly. A arm rotation motor 803 is fixedly attached to the motor mount plate 806 and is operable to rotate the arm shaft 809. A spring return plate 805 is fixedly attached to the motor mount plate 806. The spring return plate 805 is operable to engage a spring return 804 to bias the motor mount plate 806 to resist rotation on the rotation bearing assembly with respect to the lower trolley plate 802.

However, if force is exerted on the motor mount plate 806 sufficient to compress the spring return 804, the motor mount plate 806 may rotate on the rotation bearing assembly with respect to the lower trolley plate 802 in the direction of the force. For example, if a vertical boom arm attached to the arm shaft 809 impacts a vehicle during the wash process, the force of the impact transfers up the arm shaft 809 to the motor mount plate 806 and may compress the spring return 804, rotating the motor mount plate 806 on the rotation bearing assembly with respect to the lower trolley plate 802 in the direction of the force. This may result in an angular displacement between the trolley 801 and the motor mount plate 806.

FIG. 8B illustrates a top plan view of the assembly 800 of FIG. 8A. FIG. 8C illustrates a bottom plan view of the assembly 800 of FIG. 8A. FIG. 8D illustrates a close-up isometric view of the assembly 800 with the trolley 801 and several of the attachment posts 810 removed for clarity. The internal spring within spring return 804 is also illustrated for clarity. As illustrated, the spring return plate 805 includes a rotation sensor tab 811. Also as illustrated, the lower trolley plate 802 includes a proximity sensor 807 (which may be an analog proximity sensor, a digital proximity sensor, and so on) and gap stops 808. The proximity sensor 807 may detect movement of the rotation sensor tab 811 when the motor mount plate 806 rotates with respect to the trolley 801 (and thus the angular displacement between the motor mount plate 806 and the lower trolley plate 802) and may transmit data related to the amount of that movement, the rate of that movement, and the direction of that movement to a control unit. The gap stops 808 may prevent movement of the spring return plate 805 (and thus the motor mount plate 806) beyond a certain point in one or more directions, preventing actual impact between the rotation sensor tab 811 and the proximity sensor 807 and/or other components. The gap stops 808 may be adjustable to control the amount of movement the spring return plate 805 is allowed in one or more directions.

Thus, if a vertical boom arm attached to the arm shaft 809 impacts a vehicle during the wash process, the force of the impact transfers up the arm shaft 809 to the motor mount plate 806 and may compress the spring return 804, resulting in angular displacement of the motor mount plate 806 with respect to the lower trolley plate 802. The amount and rate of this displacement may be detected by the proximity sensor 807 measuring the proximity of the rotation sensor tab 811 and the proximity sensor 807 may transmit this data to a control unit.

FIG. 8E illustrates the motor mount plate 806 rotating, due to force exerted upon a vertical arm boom coupled to the arm shaft 809 sufficient to compress the spring return 804, in a clockwise direction. The proximity sensor 807 detects that the rotation sensor tab 811 has moved further away, as well as the rate of movement of the rotation sensor tab 811, and transmits that measured data to a control unit. FIG. 8F illustrates the motor mount plate 806 rotating, due to force exerted upon a vertical arm boom coupled to the arm shaft 809 sufficient to compress the spring return 804, in a direction opposite to that illustrated in FIG. 8E. The proximity sensor 807 detects that the rotation sensor tab 811 has moved closer, as well as the rate of movement of the rotation sensor tab 811, and transmits that measured data to a control unit.

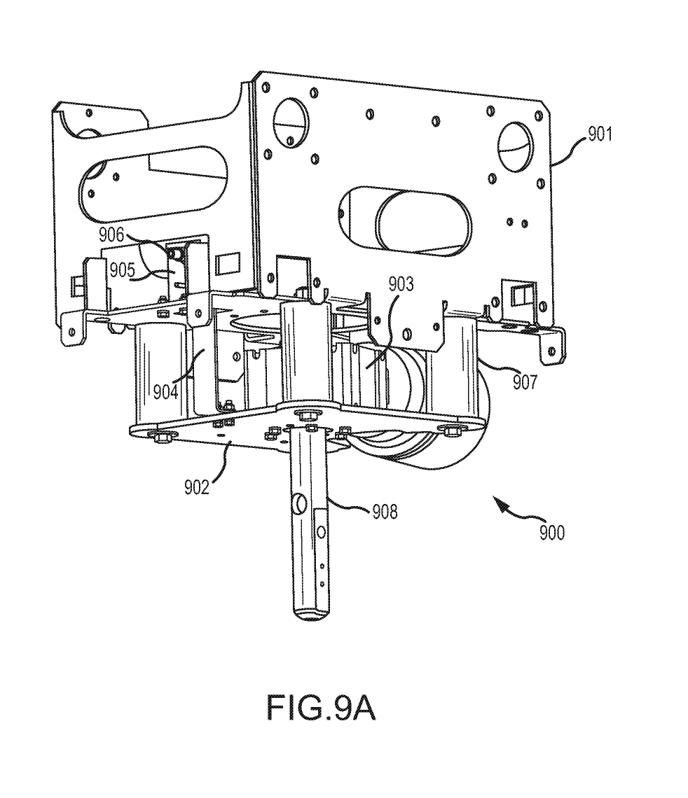

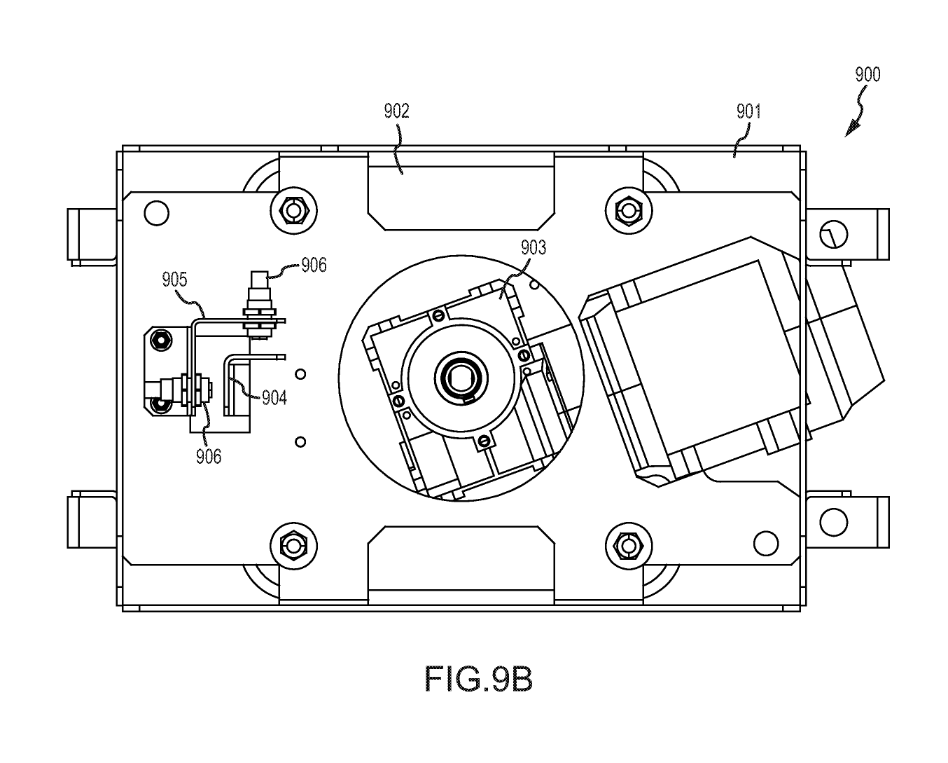

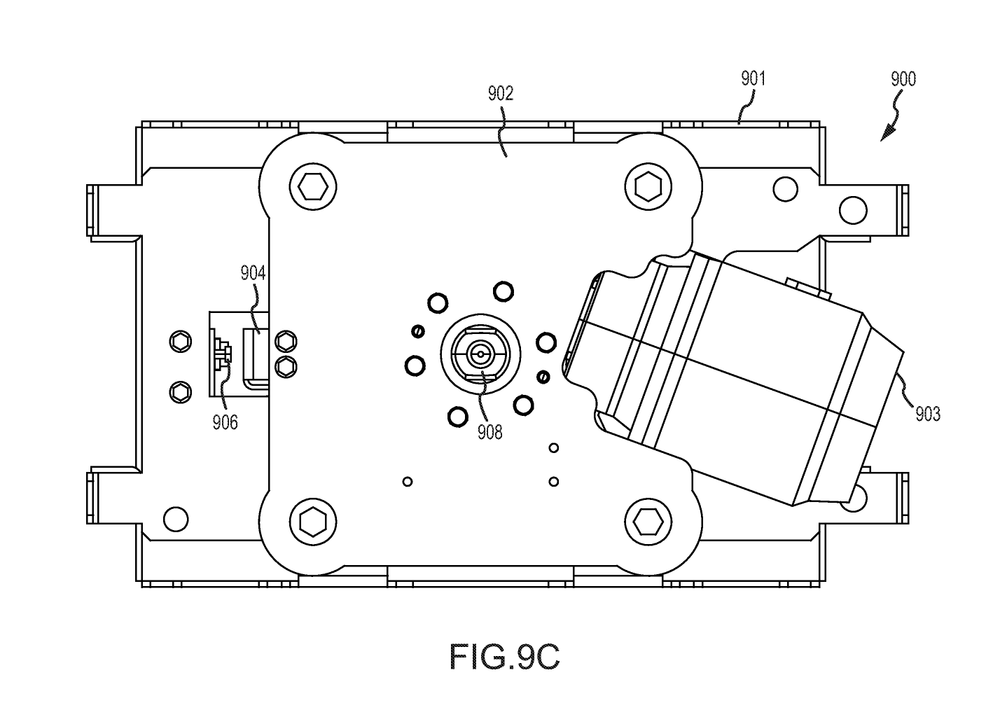

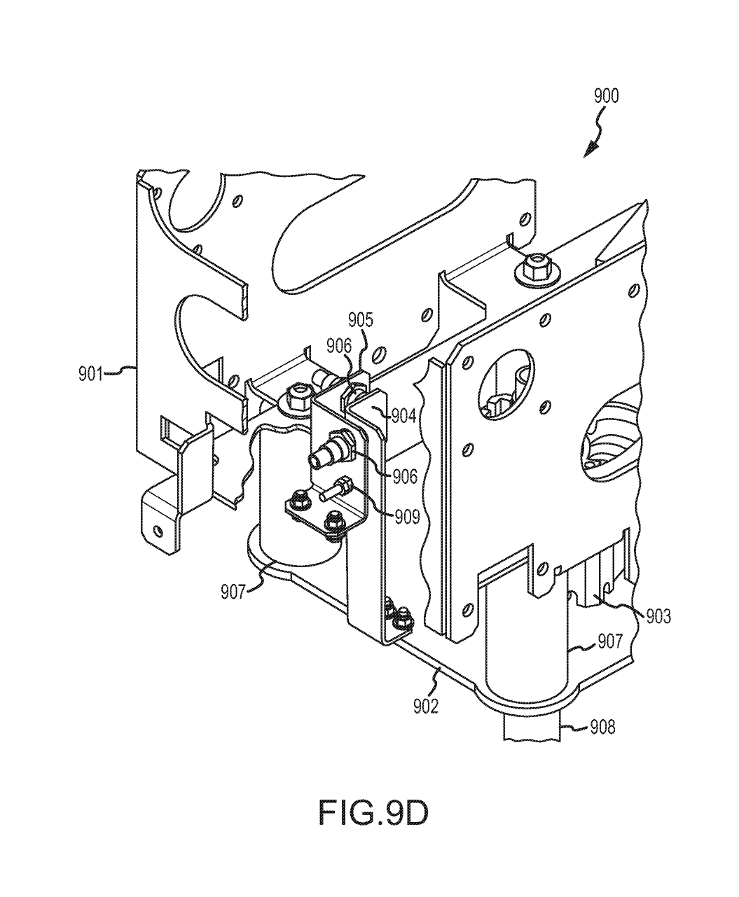

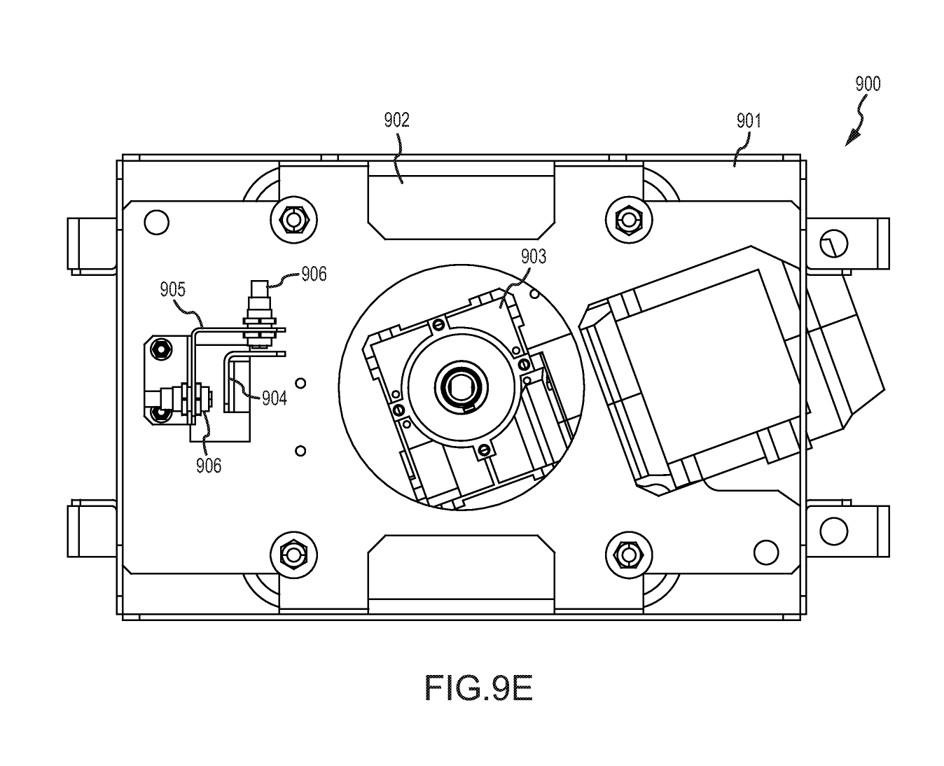

FIGS. 9A through 9F illustrate a close-up view of an assembly 900 wherein a motor mount plate 902 is flexibly attached to a trolley 901 that may be utilized in the system 100 according to a second embodiment of the present disclosure. FIG. 9A illustrates an isometric view of the assembly 900, showing the motor mount plate 902 flexibly attached to the trolley 901, removed from the system 100 for clarity. As illustrated, the assembly 900 includes the motor mount plate 902 that is flexibly attached to the trolley 901 by flexible attachment posts 907 (which may be spring-biased, rubber mounts, and so on). Also, as illustrated, an arm rotation motor 903 is fixedly attached to the motor mount plate 902 and is operable to rotate the arm shaft 908. As further illustrated, an impact target plate 904 is fixedly attached the motor mount plate 902 and a portion of the impact target plate 904 extends through an aperture in the trolley 901.

FIG. 9B illustrates a top plan view of the assembly 900. As illustrated, the portion of the impact target plate 904 that extends through the aperture in the trolley 901 is L-shaped and is positioned to face an L-shaped sensor member 905 fixedly attached to the trolley. Proximity sensors 906 are mounted on the L-shaped sensor member 905 and are operable to detect two-dimensional (along x and y planes) movement (as well as the rate of that movement) between the impact target plate 904 and the L-shaped sensor member 905 and transmit the movement and rate of movement to a control unit. The proximity sensors 906 may be analog proximity sensors, digital proximity sensors, and so on.

For example, if a vertical boom arm attached to the arm shaft 908 impacts a vehicle during the wash process, the force of the impact transfers up the arm shaft 908 to the motor mount plate 902, displacing the motor mount plate 902 with respect to the trolley 901 in the direction of the force. One or more of the proximity sensors 906 may detect the two-dimensional (along x and y planes) displacement and rate of two-dimensional displacement by detecting the change in position (and rate of change) between one or more of the proximity sensors 906 and the impact target plate 904. One or more of the proximity sensors 906 may transmit data regarding the two-dimensional displacement and rate of displacement to a control unit. The L-shaped sensor member 905 may include one or more gap stops 909 (see FIG. 9D) positioned at least partially in the gap between the L-shaped sensor member 905 and the impact target plate 904 to prevent the impact target plate 904 from directly impacting the proximity sensors 906. The gap stops 909 may be adjustable to control how close the impact target plate 904 can come to the proximity sensors 906.

FIG. 9C illustrates a bottom plan view of the assembly 900 of FIG. 9A. FIG. 9D illustrates a close-up isometric view of the assembly 900 of FIG. 9A with portions of the trolley 901 cut away to better illustrate the impact target plate 904 and the L-shaped sensor member 905.

FIG. 9E illustrates a top plan view of the assembly 900 of FIG. 9A showing two-dimensional displacement of the motor mount plate 902 in a first two-dimensional direction with respect to the trolley 901 resulting in movement of the impact target plate 904 closer to the top positioned proximity sensor 906. The top positioned proximity sensor 906 detects that the impact target plate 904 has moved closer, as well as the rate of movement of the impact target plate 904, and transmits that measured data to a control unit. FIG. 9F illustrates a top plan view of the assembly 900 of FIG. 9A showing two-dimensional displacement of the motor mount plate 902 in a second two-dimensional direction with respect to the trolley 901 resulting in movement of the impact target plate 904 closer to the lower positioned proximity sensor 906. The lower positioned proximity sensor 906 detects that the impact target plate 904 has moved closer, as well as the rate of movement of the impact target plate 904, and transmits that measured data to a control unit. Although FIGS. 9E and 9F illustrate two-dimensional displacement of the motor mount plate 902 with respect to the trolley 901 resulting in movement of the impact target plate 904 closer to one of the proximity sensors 906, it is understood that an impact may cause two-dimensional displacement of the motor mount plate 902 with respect to the trolley 901 which may result in the impact target plate 904 has moved further away from one of the proximity sensors 906, moved further away from both of the proximity sensors 906, moved closer to both of the proximity sensors 906, and so on. In such cases, one or more of the proximity sensors 906 may detect the movement, as well as the rate of movement, and transmit data about the movement to a control unit.

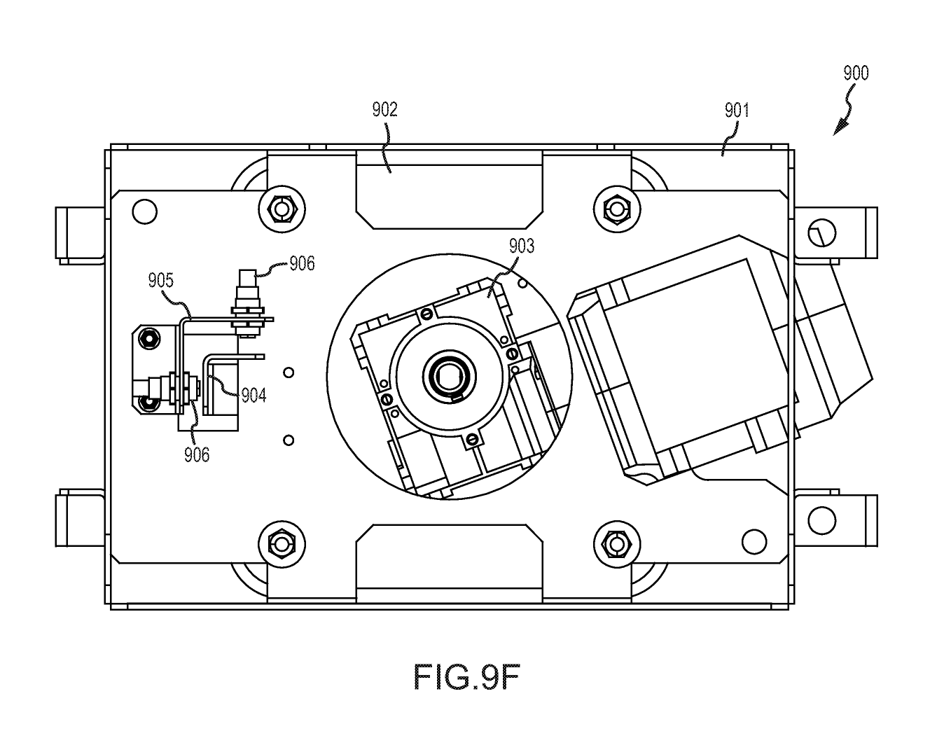

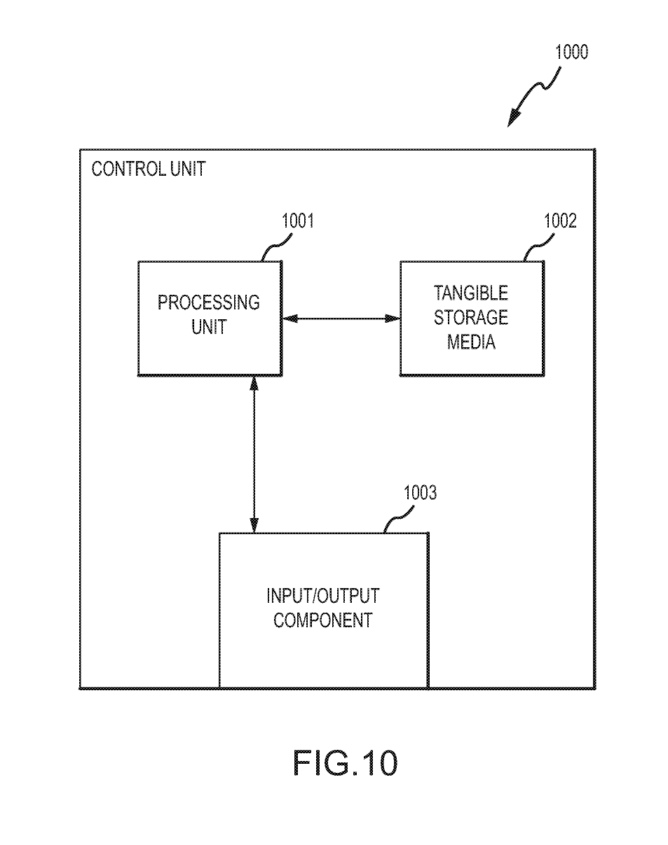

FIG. 10 illustrates an exemplary control unit 1000 that may be utilized in the system of FIG. 1 in accordance with the present disclosure. As illustrated, the control unit 1000 may include at least one processing unit 1001, tangible storage media 1002, and input/output component 1003. The tangible storage media 1002 may include any kind of tangible storage media including, but not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions. The control unit 1000 may be operable to perform the method of FIG. 7 by executing one or more instructions stores in the tangible storage media 1002.

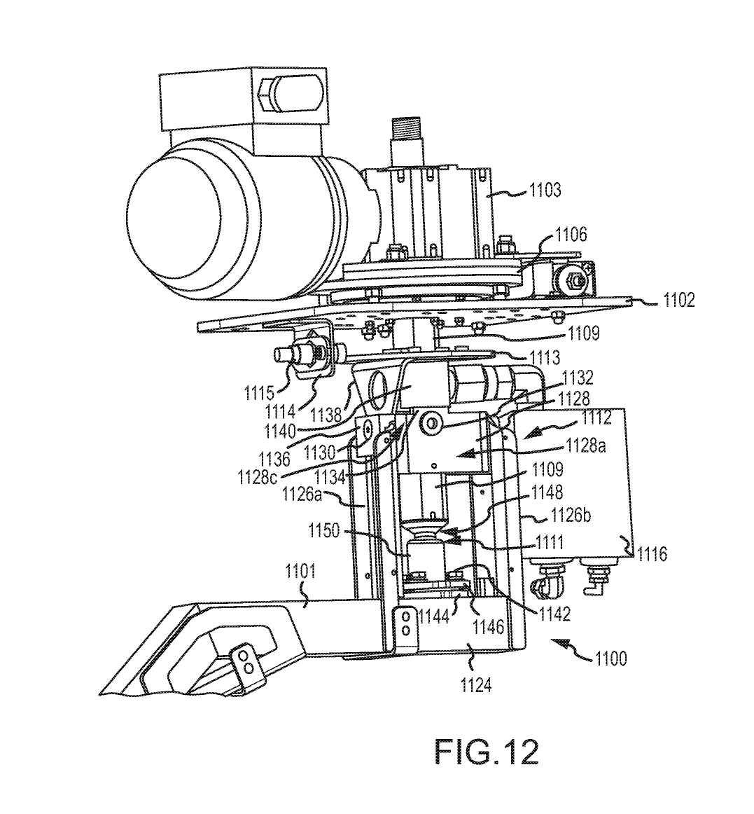

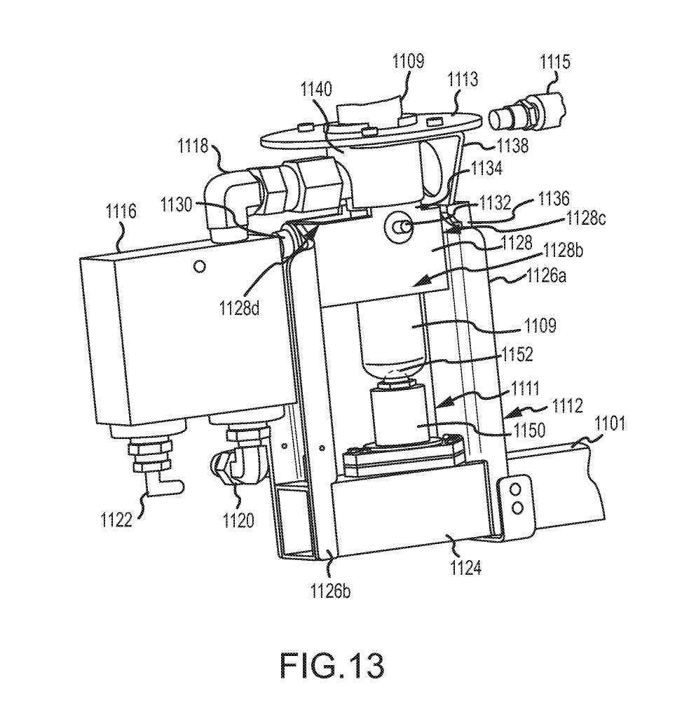

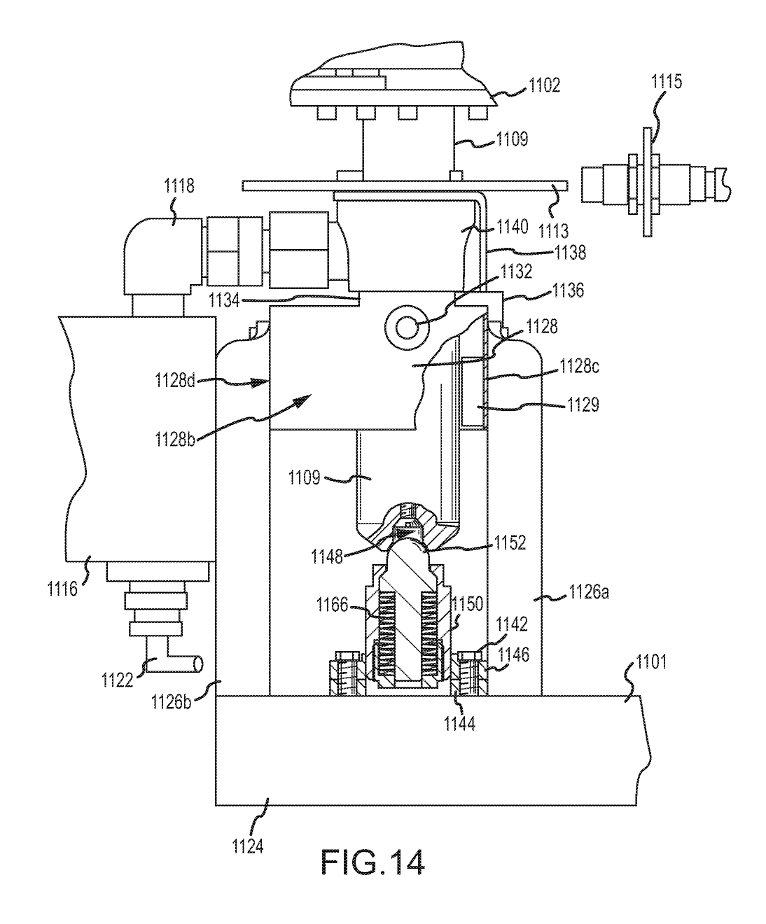

FIG. 11 is an isometric view, with parts removed for clarity, of an exemplary breakaway mechanism assembly 1100 that may be utilized in a flexible vertical boom arm attachment assembly, such as the flexible vertical boom arm attachment assemblies of FIGS. 8A-8F and/or 9A-9F. FIGS. 12 and 13 are enlarged views of the breakaway mechanism assembly 1100 as indicated in FIG. 11. FIG. 14 provides a partial cutaway view of components of the breakaway mechanism assembly 1100 to reveal internal structures.

As illustrated in this particular example, a vertical boom arm 1101 may be rotatably connected to an arm rotation motor 1103 via an arm shaft 1109. The arm rotation motor may be attached to a motor mount plate 1106 which is flexibly attached to a lower trolley plate 1102 of a trolley (not shown for clarity). The vertical boom arm 1101 may be connected to the arm shaft 1109 via a mounting assembly 1112 and a breakaway attachment mechanism 1111.

The mounting assembly 1112 may include a breakaway target plate 1113 that is mounted coaxially about the arm shaft 1109. The breakaway target plate 1113 may be disk-shaped and may define a center aperture through which the arm shaft 1109 passes. The breakaway target plate 1113 is free to move upward and downward along the arm shaft above the mounting assembly 1112. A sensor mount 1114 may be mounted to and extend from the bottom side of the lower trolley plate 1102. One or more proximity sensors 1115 may be mounted to the sensor mount and directed toward an adjacent perimeter edge of the breakaway target plate 1113. The proximity sensor 1115 may be configured to detect proximity of the breakaway target plate 1113 and may thus detect data regarding vertical movement of the breakaway target plate 1113 with respect to the lower trolley plate 1102. In one exemplary implementation, the breakaway target plate 1113 may be within a sensory field of the proximity sensor 1115 in a rest position of the breakaway mechanism assembly 1100. If the breakaway target plate 1113 moves outside of the sensory field, then the proximity sensor 1115 sends an alert to the control system. In an alternate exemplary embodiment, the breakaway target plate 1113 may be outside the sensory field of the proximity sensor 1115 in a rest position of the breakaway mechanism assembly 1100. In this alternate embodiment, if the breakaway target plate 1113 moves within the sensory field, then the proximity sensor 1115 sends an alert to the control system indicating an impact.

In some exemplary embodiments, a two-way valve 1116 may be mounted within the mounting assembly 112 and connected with a fluid flow through the center of the arm shaft 1109 via a fluid inlet connection assembly 1118. The fluid flow may enter the two-way valve 1116 and, depending upon the fluid pressure, be directed to a either a high-pressure outlet 1120 or a low-pressure outlet 1122 that direct washing fluids to high-pressure nozzle or a low-pressure nozzle, respectively, on the vertical boom arm 1101.

The mounting assembly 1112 may be attached to a horizontal section 1124 at the top of the vertical boom arm 1101 that suspends the vertical boom arm 1101 from the mounting assembly 1112. The mounting assembly 1112 may have two parallel, vertical frame members 1126a, 1126b that are attached at their bottom ends to the horizontal section 1124 of the vertical boom arm 1101. The vertical frame members 1126a, 1126b are separated by and are pivotally attached at their top ends to opposing walls 1128c, 1128d of a cage 1128 at pivot connections 1130. The cage 1128 may be a rectangular box or frame with vertical sidewalls, but without a top or bottom. The cage 1128 may itself be pivotally attached on opposing walls 1128a, 1128b to the arm shaft 1109 at pivot connections 1132. The pivotal attachment of the cage 1128 to the vertical frame members 1126a, 1126b is on the set of parallel walls 1128c, 1128d of the cage 1128 that is perpendicular to the set of parallel walls 1128a, 1128b of the cage 1128 that is attached to the arm shaft 1109. Each of the pivot connections 1130, 1132 may be formed by a pin extending through apertures in respective opposing walls of vertical frame members 1126a, 1126b, the cage 1128, and the arm shaft 1109. The apertures may or may not be lined with bushings, bearing races, or similar surfaces or structures to reduce friction in movement of the pivot connections 1130, 1132.

As shown in FIGS. 11-14, the two long walls 1128a, 1128b of the rectangular cage 1128 are the parallel walls that are attached to the arm shaft 1109. The two long walls 1128a, 1128b may each have a tab 1134 that extends above the majority of the perimeter of the top edge of the walls of the cage 1128 for a short section above the pivot connections 1132 on the two long walls 1128a, 1128b. Further, the cage 1128 is pivotally connected to the arm shaft 1109 at a position laterally off-center along the long walls of the cage 1128. As shown in FIG. 14, a spacer 1129 is mounted within the cage 1128 against one of the short walls 1128c, in particular the short wall 1128c oriented away from the terminal end of the horizontal section 1124 of the vertical boom arm 1101, such that the arm shaft 1109 is positioned directly against the spacer 1129. In this manner, while the cage 1128 can pivot in one direction on the pivot connection 1132 with respect to the arm shaft 1109 (i.e., in a direction such that the vertical boom arm 1101 can move upward and outward as further described below), the cage 1128 cannot pivot in the opposite direction on the pivot connection 1132 with respect to the arm shaft 1109 (i.e., in a direction such that the vertical boom arm 1101 cannot move downward and inward as further described below) because the spacer 1129 on the cage 1128 interferes with the arm shaft 1109, thereby preventing movement in this direction.

An engagement plate 1136 may be mounted at the top end of the vertical frame member 1126a that is oriented away from the terminal end of the horizontal section 1124 of the vertical boom arm 1101. An engagement bracket 1138 may be mounted to the underside of the breakaway target plate 1113 and extend downward to interface with a top edge of the engagement plate 1136 as shown in FIG. 12. A sleeve or bushing 1140 may also be slideably mounted about the arm shaft 1009 between the top of the cage 1128 and the bottom of the breakaway target plate 1113. The bushing may be formed of any suitable rigid material able to be formed in the desired tubular, cylindrical shape. In one exemplary embodiment, the bushing 1140 may be formed out of a rigid plastic with a low coefficient of friction to aid the movement of the bushing up and down along the arm shaft 1109. A bottom edge of the bushing 1140 may have a semicircular cutout to fit around the fluid inlet connection assembly 1118 extending from the side of the arm shaft 1109 above the cage 1128. The bushing 1140 may be of a large enough outer diameter that the bottom edge of the bushing 1140 may rest upon and be supported by the tabs 1134 on the top edge of the cage 1128. The top edge of the bushing 1140 may support the bottom of the breakaway target plate 1113 and hold the breakaway target plate 1113 in its rest position with respect to the proximity sensor 1115.

The mounting assembly 1112 may further be composed of a breakaway attachment mechanism 1111 mounted upon the top of the horizontal section 1124 of the vertical boom arm 1101 that interfaces with the bottom of the arm shaft 1109 that extends below the cage 1128. In one exemplary implementation, the breakaway attachment mechanism 1111 may be a spring-loaded ball detent plunger 1152 housed within a canister 1150 that interfaces with a detent receiver 1148 which may be formed as a recess or aperture within the bottom of the arm shaft 1109. The canister 1150 may have a flange 1146 formed about its base that seats upon a surface mount 1144 provided upon the top surface of the horizontal section 1124 of the vertical boom arm 1101. In one exemplary implementation as shown in FIG. 12, the flange 1146 may be attached to the surface mount 1144 with bolts 1142 that pass through apertures in the flange and screw into corresponding threaded apertures formed in the surface mount 1144. In other embodiments, the canister 1150 may be mounted to the horizontal section 1124 using other methods, for example, clamping, welding, or threading the canister 1150 directly to the surface mount 1144 or directly to the horizontal section 1124. In further embodiments, the breakaway attachment mechanism 1111 may be mounted on the arm shaft 1109 and the detent receiver 1148 may be located on the horizontal section 1124 of the vertical boom arm 1101.

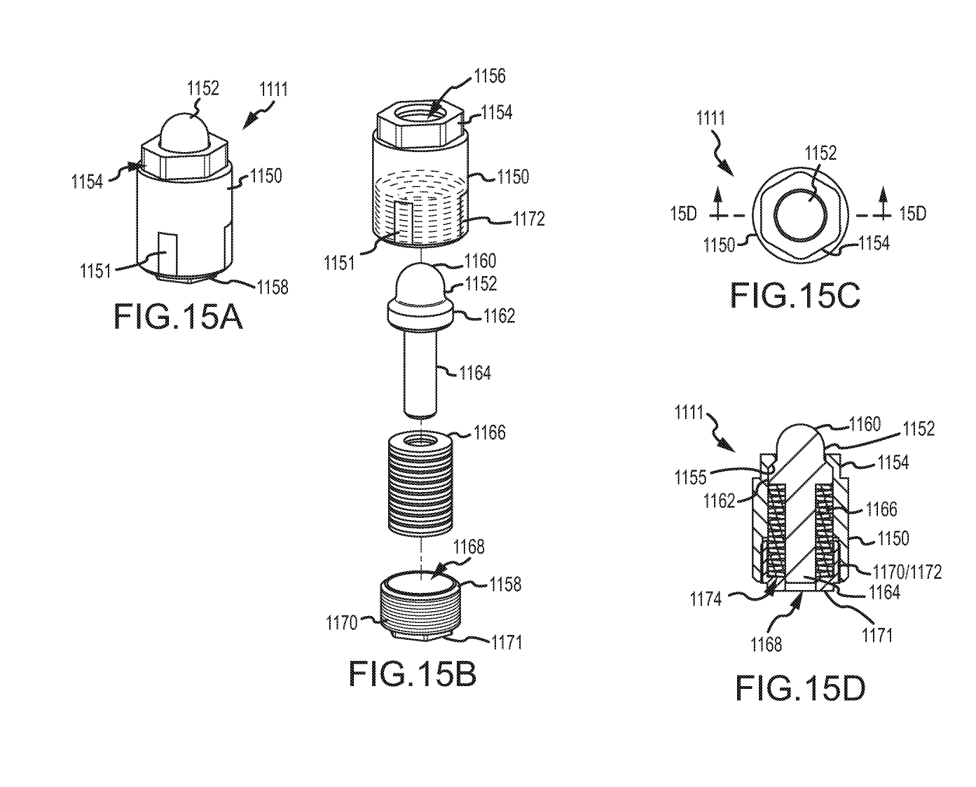

The exemplary breakaway attachment mechanism 1111 is shown in greater detail in FIGS. 15A-15D. The detent plunger 1152 has a rounded top 1160 that transitions into a wider diameter shoulder 1162 that extends from the top of a narrower diameter cylindrical post 1164. The post 1164 is provided to align and retain a bias mechanism 1166 that places the ball detent 1154 in tension within the canister 1150 and with respect to the base of the arm shaft 1109 defining the detent receiver 1148 as shown in FIG. 14. In one exemplary embodiment, the bias mechanism 1166 is formed by a stack of Belleville washers placed in alternating orientations (i.e., concave up, convex up, concave up, convex up, etc.) as shown in FIG. 15D. In this manner, the washers forming the bias mechanism 1166 provide a very strong spring force over a short distance that is further easily adjustable by either adding or removing washers from the stack or by changing the gauge of metal or other material forming the washers used in the stack, or both. The Belleville washers can also be stacked uniformly (e.g., concave up, concave up, etc.) to achieve different spring characteristics. In alternative embodiments, other biasing mechanisms 1166 may be used, for example, springs, hydraulics, pneumatics, etc.

The canister 1150 that holds the detent plunger 1152 may have a top portion 1154 that defines a top aperture 1156 through which the rounded top 1160 of the detent plunger 1152 protrudes when biased by the bias mechanism 1166. The canister 1150 may couple with a base cap 1158 to retain the detent plunger 1152 within the canister 1150. Either the canister 1150 or the base cap 1158 may be retained within or connected to the flange 1146 depending upon the desired configuration. For example, the flange 1146 could clamp around or be welded to either the canister 1150 or the bottom cap 1158. In the exemplary embodiments depicted in FIGS. 12-14, the canister 1150 is clamped within the flange 1146, which grips the sidewall facets 1151 of the canister 1150. The top portion 1154 may define a shelf 1155 within the interior of the canister 1150 that interfaces with the shoulder 1162 of the detent plunger 1152 to retain the detent plunger 1152 within the canister 1150.

The top portion 1154 may further be faceted to accept the faces of a wrench, ratchet head, pliers, or other tool for tightening or loosening the canister with respect to the base cap 1158. The interior wall of the bottom portion of the canister 1150 may be threaded. Likewise, an exterior wall 1170 of the base cap 1158 may be threaded and the diameter of the base cap 1158 may be sized to interface with the threaded interior wall 1172 of the canister 1150. In this way, the canister 1150 and the base cap 1158 may be screwed together to retain the detent plunger 1152 and the bias mechanism 1166. An interior wall of the base cap 1158 formed in part by a bottom portion 1171 of the base cap 1158 may form a ledge 1174 upon which the biasing mechanism 1166 is supported. An exterior surface of the bottom portion 1171 of the base cap 1158 may further be faceted to accept the faces of a wrench, ratchet head, pliers, or other tool for tightening or loosening the base cap 1158 with respect to the canister 1152.

By screwing and unscrewing the canister 1150 and the base cap 1158 with respect to each other, the spring force provided by the bias mechanism 1166 may be increased and decreased. Further, if the embodiment depicted in FIGS. 14, 15B, and 15D with Belleville washers as the bias mechanism 1166 is used, the canister 1150 and the base cap 1158 may be taken apart and springs may be added or removed to adjust the bias force. The length of the cavity within the canister 1150 and the base cap 1158 may be lengthened and shortened to accommodate greater or fewer washers by adjusting the length of the threaded interface between the canister 1150 and the base cap 1158. The base cap may further define an aperture 1168 within the bottom wall of a diameter large enough to receive the post 1164 of the detent plunger 1152 while still forming the ledge 1174 supporting the bias mechanism 1166. The aperture 1168 allows the post 1164 to extend downward if the canister 1150 and the base cap 1158 are screwed together in a short length configuration or if the detent plunger 1152 is depressed during operation as further described below.

In standard operation, the vertical boom arm 1101 remains in a static position with respect to the trolley plate 1102, even though the mounting assembly 1112 is pivotally mounted with respect to the arm shaft 1109, and thus the trolley plate 1102, due to the interface of the detent plunger 1152 with the bottom of the arm shaft 1109. When the rounded top 1160 of the detent plunger 1152 is engaged with the detent receiver 1148 on the bottom of the arm shaft 1109, there may be a gap between the shoulder 1162 and interior shelf 1155 to ensure positive contact between the detent plunger 1152 and the detent receiver 1148. Thus, the rounded top 1160 engages the edge of the detent receiver 1148 on the arm shaft 1109 and maintains the mounting assembly 1112 in a fixed position with respect to the arm shaft 1109 and the trolley plate 1102.

When the vertical boom arm 1101 is involved in an impact that occurs with sufficient force, the breakaway attachment mechanism 1111 may be configured to disengage the vertical boom arm 1101 from the arm shaft 1109. Forces with horizontal components acting on the vertical boom arm 1101 (e.g., a car running into the vertical boom arm 1101; a car door opening into the vertical boom arm 1101; the trolley running the vertical boom arm 1101 into the side of a car) may create sufficient torque on the vertical boom arm 1101 that the force of the bias mechanism 1166 pushing the detent plunger 1152 into the detent receiver 1148 is overcome. In such a case, round top 1160 of the detent plunger 1152 may be pressed against the edge of the detent receiver 1148 on the bottom of the arm shaft 1109 thereby translating an opposing force from the impact against the bias mechanism 1166 and thrusting the ball detent 1158 downward into the canister 1150. In this manner the spring-loaded detent plunger 1152 is disengaged from the arm shaft 1109 and the mounting assembly 1112 may pivot with respect to the arm shaft 1109, allowing the vertical boom arm 1101 to move in the direction of the impact force and thereby avoid or minimize damage to the car.

Additionally, disengagement of the vertical boom arm 1101 from the arm shaft 1109 may cause the breakaway target plate 1113 to displace vertically from the proximity sensor 1115. As a result, the proximity sensor 1115 may detect that a breakaway of the vertical boom arm 1101 has occurred and the resultant signal from the proximity sensor 1115 to the control system may cause the control system to abandon the current wash, remain dormant until the breakaway mechanism is reset and the automatic vehicle wash is reset, and/or otherwise cease movement of the trolley, gantry, and arm shaft 1109 in order to prevent damage to a vehicle and/or the automatic vehicle wash.

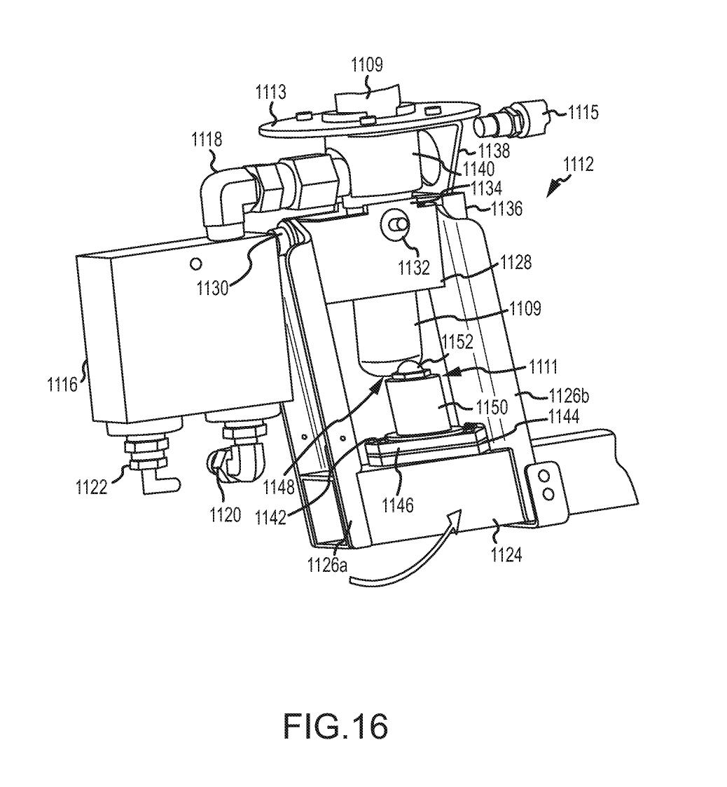

FIGS. 16-18 illustrate several examples of effects on the mounting assembly 1112 of collisions with or impacts to the vertical boom arm 1101. FIG. 16 depicts a lateral force acting on the vertical boom arm 1101, and thus on the mounting assembly 1112, in a direction parallel to a side of the vehicle being washed as indicated by the arrow. As shown in FIG. 16, if the impact force on the vertical boom arm 1101 is strong enough, the force translated to the interface between the breakaway attachment mechanism 1111 and the arm shaft 1109, pushing the detent plunger 1152 within the container 1150 and dislodging the detent plunger 1152 from the detent receiver 1148 in the arm shaft 1109. The mounting assembly 1112 swings to the side on pivot connections 1130 with respect to the cage 1128 mounted on the arm shaft 1109 as shown in FIG. 16. In this way, the vertical boom arm 1101 moves in the direction of the impact if the force is great enough to overcome the resistance of the bias mechanism 1166 in order to avoid damage to a vehicle and/or the vertical boom arm 1101 if the vertical boom arm 1101 were to remain fixed in response to the impact. The mounting system 1112 allows the vertical boom arm 1101 to disengage from the arm shaft 1109 and swing laterally in either direction along the side of a vehicle.

In addition to allowing the vertical boom arm 1101 to move with the impact, the mounting assembly 1112 further provides an indication of the impact to the control system. As shown in FIG. 16, as the mounting assembly 1112 swings to the side, there is a vertical component to the pivot movement around pivot connections 1130. As the mounting assembly 1112 pivots, the engagement plate 1136 pushes upward on the engagement bracket 1138, thereby pushing the breakaway target plate 1113 upward on the arm shaft 1109. The breakaway target plate 1113 thus moves to a plane above the plane of the proximity sensor 1115 and the proximity sensor 1115 is thereby triggered to send a signal to the control system that the vertical boom arm 1101 has received a significant impact and that it has become disengaged from the arm shaft 1101. The control system may then arrest the wash process until a technician or operator can reset the vertical boom arm 1101 and ensure that there are no obstacles within the wash bay that might further impede the ability of the automatic car wash system to complete the vehicle wash process.

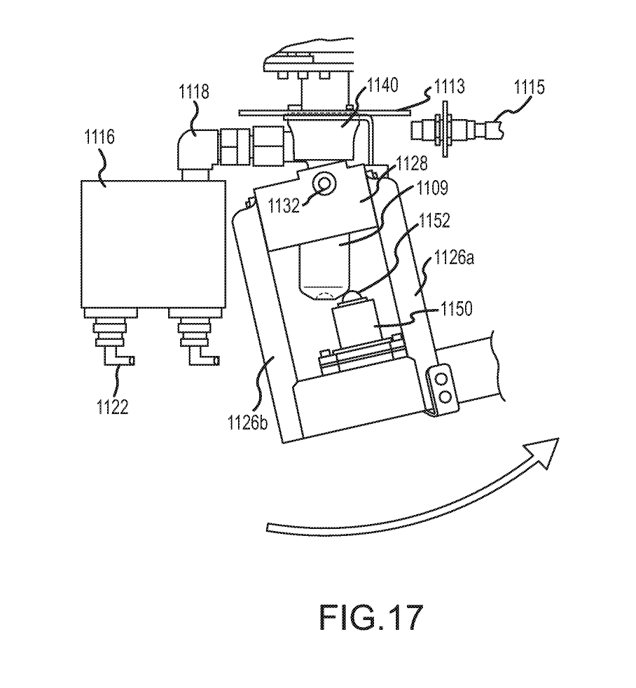

FIG. 17 depicts a normal force acting on the vertical boom arm 1101, and thus on the mounting assembly 1112, in a direction perpendicularly away from a side of the vehicle being washed as indicated by the arrow. As shown in FIG. 17, if the impact force on the vertical boom arm 1101 is strong enough, the force translated to the interface between the breakaway attachment mechanism 1111 and the arm shaft 1109, pushing the detent plunger 1152 within the container 1150 and dislodging the detent plunger 1152 from the detent receiver 1148 in the arm shaft 1109. The mounting assembly 1112 swings outward on pivot connections 1132 on the cage 1128 with respect to the arm shaft 1109 as shown in FIG. 17. In this way, the vertical boom arm 1101 moves in the direction of the impact if the force is great enough to overcome the resistance of the bias mechanism 1166 in order to avoid damage to a vehicle and/or the vertical boom arm 1101 if the vertical boom arm 1101 were to remain fixed in response to the impact. The mounting system 1112 allows the vertical boom arm 1101 to disengage from the arm shaft 1109 and swing outward away from the side of the vehicle.

In addition to allowing the vertical boom arm 1101 to move with the impact, the mounting assembly 1112 further provides an indication of the impact to the control system. As shown in FIG. 17, as the mounting assembly 1112 swings outward, there is a vertical component to the pivot movement around pivot connections 1132. As the mounting assembly 1112 pivots, the tabs 1134 on the cage 1128 push the bushing 1140 which slides upward on the arm shaft 1109, thereby pushing the breakaway target plate 1113 upward on the arm shaft 1109. The breakaway target plate 1113 thus moves to a plane above the plane of the proximity sensor 1115 and the proximity sensor 1115 is thereby triggered to send a signal to the control system that the vertical boom arm 1101 has received a significant impact and that it has become disengaged from the arm shaft 1109. The control system may then arrest the wash process until a technician or operator can reset the vertical boom arm 1101 and ensure that there are no obstacles within the wash bay that might further impede the ability of the automatic car wash system to complete the vehicle wash process.

It should be noted that impacts from angles other than directly lateral or normal to the vehicle can cause the detent plunger 1152 to disengage from the arm shaft 1109 and activate the proximity sensor 1115. In such situations, the mounting assembly 1112 may pivot both on pivot connections 1130 and on pivot connections 1132 and the boom arm may thereby move in an angular direction with respect to the vehicle in the direction of the impact force. In such situations, both the engagement bracket 1138 and the bushing 1140 may in concert push the breakaway target plate 1113 upward along the arm shaft 1109 and out of the range of the proximity sensor 1115 to alert the control system to the impact.

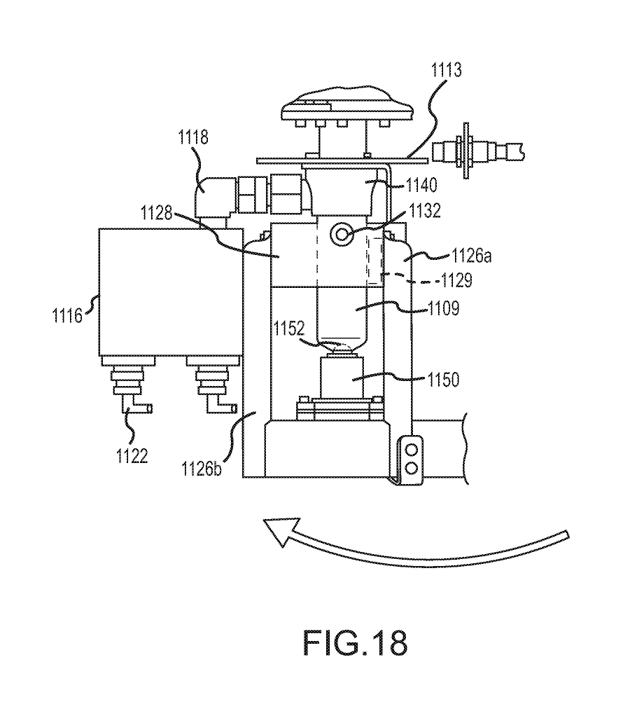

FIG. 18 depicts a normal force acting on the vertical boom arm 1101, and thus on the mounting assembly 1112, in a direction perpendicularly toward a side of the vehicle being washed as indicated by the arrow. As shown in FIG. 18, an impact on the vertical boom arm 1101 will not dislodge the detent plunger 1152 from the detent receiver 1148 in the arm shaft 1109 because of the interface between the spacer 1129 mounted within the cage 1128 against the outer short wall 1128c. An inward normal force translated to the mounting assembly 1112 by an impact to the vertical boom arm 1101 is arrested by this interface because the cage 1128 cannot pivot on pivot connections 1132 due to the interference between the spacer 1129 and the arm shaft 1109. In this way, the vertical boom arm 1101 is prevented from rotating in the direction of an impact toward a vehicle in order to avoid damage to a vehicle. If the impact is large enough, it may still cause the proximity sensors on the trolley to register an impact and either move the vertical boom arm 1101 to a safe position or arrest the wash process until a technician can ensure that there are no obstacles within the wash bay that might further impede the ability of the automatic car wash system to complete the vehicle wash process.

Although the present disclosure has been described with a certain degree of particularity, it is understood the disclosure has been made by way of example and changes in detail or structure may be made without departing from the spirit of the disclosure as defined in the appended claims. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The technology described herein may be at least partially implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein may be referred to variously as operations, steps, objects, engines, or modules. Furthermore, it should be understood that logical operations may be performed in any order, unless explicitly claimed otherwise or a specific order is inherently necessitated by the claim language.

In some implementations, articles of manufacture may be provided as computer program products that cause the instantiation of operations on a computer system to implement one or more portions of the disclosure. One implementation of a computer program product provides a computer program storage medium readable by a computer system and encoding a computer program.

The above specification, examples, and data provide a complete description of the structure and use of exemplary embodiments of the disclosure. Although various embodiments of the disclosure have been described above with a certain degree of particularity, or with reference to one or more individual embodiments, those skilled in the art could make numerous alterations to the disclosed embodiments without departing from the spirit or scope of this disclosure. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the disclosure as defined in the following claims.

What is claimed is:

1. An operator-resettable, breakaway wash arm mount for an automatic vehicle wash comprising
a support structure;
a wash arm pivotally coupled with the support structure about two separate axes;
a breakaway attachment mechanism mounted either to the wash arm or to the support structure that in normal operation interfaces with the other of the wash arm or to the support structure opposite the breakaway attachment mechanism to maintain the wash arm in a fixed position with respect to the support structure; wherein
upon an impact force to the wash arm from any direction in a horizontal plane sufficient to overcome a force supplied by the interface between the breakaway attachment mechanism and either the wash arm or the support structure, the breakaway attachment mechanism disengages from either the wash arm or the support structure and allows the wash arm to pivotally move with respect to the support structure in a direction of the impact force; and
the breakaway attachment mechanism can be manually reset with respect to either the wash arm or the support structure.

2. The breakaway wash arm mount of claim 1, wherein
the breakaway attachment mechanism further comprises a detent plunger and a bias mechanism; and
the breakaway wash arm mount further comprises a detent receiver mounted to the other of the wash arm or to the support structure opposite the detent plunger;
in normal operation, the detent plunger is retained in the detent receiver by the bias mechanism to maintain the wash arm in a fixed position; and
upon the impact force being sufficient to overcome a force supplied by the bias mechanism, the detent plunger disengages from the detent receiver and allows the wash arm to pivotally move with respect to the support structure in a direction of the impact force.

3. The breakaway wash arm mount of claim 2, wherein the bias mechanism comprises a spring.

4. The breakaway wash arm mount of claim 2, wherein the bias mechanism comprises a plurality of Belleville washers, each having a convex side and a concave side, that are stacked in an alternating arrangement such that convex sides are adjacent convex sides and concave sides are adjacent concave sides.

5. The breakaway wash arm mount of claim 2, wherein the bias mechanism comprises a plurality of Belleville washers, each having a convex side and a concave side, that are stacked in a uniform arrangement such that convex sides are adjacent concave sides.

6. The breakaway wash arm mount of claim 1 further comprising a motion limiting structure that substantially limits the pivotal movement of the wash arm in a particular direction of the impact force.

7. The breakaway wash arm mount of claim 6, wherein the particular direction is toward a vehicle in the automatic vehicle wash.

8. The breakaway wash arm mount of claim 1, wherein the two separate axes are orthogonal to each other.

9. The breakaway wash arm mount of claim 1 further comprising
a breakaway target plate movably mounted to the support structure;
a proximity sensor fixedly mounted to the support structure; wherein
when the wash arm pivotally moves with respect to the support structure, the breakaway target plate moves with respect to the proximity sensor to effect a change in output of the proximity sensor indicating disengagement of the breakaway attachment mechanism.

10. The breakaway wash arm mount of claim 9, wherein
when the wash arm pivotally moves about a first of the two axes with respect to the support structure, a first engagement structure interfaces with the breakaway target plate to effect the movement with respect to the proximity sensor; and
when the wash arm pivotally moves about a second of the two axes with respect to the support structure, a second engagement structure interfaces with the breakaway target plate to effect the movement with respect to the proximity sensor.

11. The breakaway wash arm mount of claim 1, wherein the support structure is further configured to rotate on a vertical axis upon the impact force to the wash arm.

12. An operator-resettable, breakaway wash arm mount for an automatic vehicle wash comprising
a support structure;
a rotatable wash arm shaft extending from the support structure;
a wash arm pivotally coupled with the wash arm shaft about two separate axes;
a detent plunger mounted either to the wash arm or to the wash arm shaft;
a detent receiver mounted to the other of the wash arm or to the wash arm shaft opposite the detent plunger; and
a bias mechanism that biases the detent plunger against the detent receiver; wherein
in normal operation, the detent plunger is retained in the detent receiver to maintain the wash arm in a fixed position with respect to the support structure;
upon an impact force to the wash arm from any direction in a horizontal plane sufficient to overcome a force supplied by the bias mechanism, the detent plunger disengages from the detent receiver and allows the wash arm to pivotally move with respect to the support structure in a direction of the impact force; and
the detent plunger can be manually reset within the detent receiver.

13. The breakaway wash arm mount of claim 12, wherein the bias mechanism comprises a spring.

14. The breakaway wash arm mount of claim 12, wherein the bias mechanism comprises a plurality of Belleville washers, each having a convex side and a concave side, that are stacked in an alternating arrangement such that convex sides are adjacent convex sides and concave sides are adjacent concave sides.

15. The breakaway wash arm mount of claim 12, wherein the bias mechanism comprises a plurality of Belleville washers, each having a convex side and a concave side, that are stacked in a uniform arrangement such that convex sides are adjacent concave sides.

16. The breakaway wash arm mount of claim 12 further comprising a motion limiting structure that substantially limits the pivotal movement of the wash arm in a particular direction of the impact force.

17. The breakaway wash arm mount of claim 16, further comprising
a cage positioned between the wash arm and the wash arm shaft, wherein
a first pivot coupling of the wash arm is between the wash arm and the cage about a first axis of the two separate axes;
a second pivot coupling of the wash arm is between the cage and the wash arm shaft about a second axis of the two separate axes;
the motion limiting structure is provided by an interface between a wall of the cage and the wash arm shaft.

18. The breakaway wash arm mount of claim 16, wherein the particular direction is toward a vehicle in the automatic vehicle wash.

19. The breakaway wash arm mount of claim 12, wherein the two separate axes are orthogonal to each other.

20. The breakaway wash arm mount of claim 12 further comprising
a breakaway target plate movably mounted to the support structure;
a proximity sensor fixedly mounted to the support structure; wherein
when the wash arm pivotally moves with respect to the support structure, the breakaway target plate moves with respect to the proximity sensor to effect a change in output of the proximity sensor indicating disengagement of the breakaway attachment mechanism.

21. The breakaway wash arm mount of claim 20, wherein
when the wash arm pivotally moves about a first of the two axes with respect to the support structure, a first engagement structure interfaces with the breakaway target plate to effect the movement with respect to the proximity sensor; and
when the wash arm pivotally moves about a second of the two axes with respect to the support structure, a second engagement structure interfaces with the breakaway target plate to effect the movement with respect to the proximity sensor.

22. The breakaway wash arm mount of claim 21, wherein the first engagement structure comprises a slideable bushing positioned about the wash arm shaft.

23. The breakaway wash arm mount of claim 12, wherein the support structure is further configured to rotate on a vertical axis upon the impact force to the wash arm.
